(19) United States
(12) Patent Application Publication
(10) Pub. No.: US 2026/0023568 A1
(43) Pub. Date: Jan. 22, 2026

(54) DATA PROCESSING UNIT

(71) Applicant: Arm Limited, Cambridge (GB)

(72) Inventors: Elliot Maurice Simon ROSEMARINE, London (GB); Jens OLSON, San Jose, CA (US); John Wakefield BROTHERS, III, Calistoga, CA (US); Dominic Hugo SYMES, Cambridge (GB); Thomas NYBERG, Lund (SE); Ola Markus LEMBKE, Lomma (SE)

(21) Appl. No.: 18/778,021

(22) Filed: Jul. 19, 2024

(51) Int. Cl. G06F 9/38; G06F 9/48

(52) U.S. Cl. CPC G06F 9/3826; G06F 9/485

(57) ABSTRACT

A data processing unit is provided comprising a handling unit configured to send invocation data including the first and second operation to an execution unit to cause the execution unit to process the invocation data. The execution unit processes the data by: obtaining data from a non-local storage based on a logical source pipe of a first operation, performing the first and a second operation for portions of the data received from the logical source pipe. In response to the output of the first operation and input of the second operation referring to a logical forwarding pipe, the execution unit performs processing for a portion of the data for the first and second operation without storing the output data of the first operation in the non-local storage.

### BACKGROUND OF THE INVENTION

### Field of the Invention

The present invention relates to a data processing unit, a method of performing a plurality of operations in a processing unit, and a non-transitory computer-readable storage medium storing computer-readable instructions for a compiler.

### Description of the Related Technology

An NPU (neural processing unit) is a specialized piece of hardware designed to optimize the performance of tasks related to artificial intelligence and neural networks. NPUs are increasingly common and are used for tasks such as autonomous driving and natural language processing, as well as face recognition, and voice recognition. NPUs typically include many processing elements and associated control structures that allow efficient processing of the numerous calculations in neural network and machine learning workloads.

GPU (graphics processing units) were originally developed for rendering graphics in video games and multimedia applications. GPU typically have hardware that is optimized for graphics processing tasks such as rendering graphics, simulating physics (e.g. ray tracing), and other tasks that require parallel processing. GPU may also find applications in processing tasks relates to artificial intelligence and neural networks.

Data processing techniques, such as neural network processing and graphics processing, involve the processing and generation of considerable amounts of data using operations. It is desirable to efficiently handle this data when processing the data using an operation set.

### SUMMARY

According to a first aspect there is provided a processing unit, comprising a handling unit and an execution unit, wherein the handling unit is configured to: receive task data in the form of a directed graph including at least a first operation and a second operation, wherein the task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe; parse the task data to form invocation data to send to an execution unit within the processing unit, wherein the operations included in the invocation data are determined by parsing the task data to identify the first and second operations; map the first and second operation of the task data to the execution unit and allocate storage in a non-local storage that is remote from the execution unit for the logical source pipe and logical destination pipe; and send the invocation data including the first and second operation to the execution unit to cause the execution unit to process the invocation data by: obtaining data from the non-local storage based on the logical source pipe of the first operation, performing the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.

According to a second aspect there is provided a method of performing a plurality of operations in a processing unit, comprising: receiving task data in the form of a directed graph, by a handling unit of the processing unit, including a first operation and a second operation, wherein task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe; parsing, by the handling unit, the task data to form invocation data to send to an execution unit within the processing unit, wherein the operations included in the invocation data are determined by parsing the task data to identify the first and second operations; mapping the first and second operation of the task data to the execution unit and allocating storage in a non-local storage that is remote from the execution unit for the logical source pipe and logical destination pipe; sending the invocation data including the first and second operation to the execution unit; and processing the invocation data, by the execution unit, by obtaining data from a non-local storage that is remote from the execution unit based on the logical source pipe of the first operation, performing the first and second operation for portions of the data received from the logical source pipe, wherein in response to the output of the first operation and input of the second operation referring to the logical forwarding pipe, the execution unit performs the processing for the first and second operation for a portion of the data without storing the output data of the first operation in the non-local storage.

According to a third aspect there is provided a non-transitory computer-readable storage medium storing computer-readable instructions for a compiler that, when executed by a processing unit, cause the processing unit to generate task data in the form of a directed graph including a first operation and a second operation, wherein the task data includes configuration data that indicates that the first operation receives data from a logical source pipe and that the second operation outputs data to a logical output pipe, and wherein the configuration data indicates that the first operation outputs data to a logical forwarding pipe and the second operation receives data from the logical forwarding pipe; wherein, when processed by an execution unit in a second processing unit, an execution unit of the second processing unit is caused to: obtain data from a non-local storage based on the logical source pipe of the first operation, perform the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.

### BRIEF DESCRIPTION OF THE DRAWINGS

Further features and advantages will become apparent from the following description of preferred embodiments, given by way of example only, which is made with reference to the accompanying drawings in which like reference numerals are used to denote like features.

FIG. 1a illustrates an example directed graph in which sections are interconnected by a series of pipes;

FIG. 1b is a schematic diagram of a data processing system;

FIG. 2 is a schematic diagram of a neural engine;

FIG. 3 shows schematically an example system for allocating handling data;

FIG. 4 is a table showing data relating to a number of sections;

FIG. 5 is a table showing further data relating to a number of sections;

FIG. 6 illustrates an example progression of operations to be performed;

FIG. 7 illustrates an example corresponding coordinate space.

FIG. 8 illustrates an example of scheduling of the blocks shown in FIG. 7;

FIG. 9 is a flow-chart of efficient data processing;

FIG. 10 is a schematic diagram showing components of a vector engine;

FIG. 11 is a flowchart showing steps performed by a compiler application;

FIG. 12 is a flowchart showing steps performed by a handling unit to generate invocation data;

FIG. 13 is a table showing the order of performance of operations by the vector engine;

FIG. 14 is a schematic diagram illustrating an example sequence of operations;

FIGS. 15a and 15b are further schematic diagrams showing example sequences of operations;

FIG. 16 is a schematic diagram showing a further example sequence of operations;

FIG. 17 is a schematic diagram showing a further example sequence of operations; and

FIG. 18 illustrates manufacture of a system and a chip-containing product.

### DETAILED DESCRIPTION OF CERTAIN INVENTIVE EMBODIMENTS

Examples herein relate to a processor for handling data, the processor comprising a handling unit, a plurality of storage elements, and a plurality of execution units. The processor is configured to obtain, from storage, task data that describes a task to be executed in the form of a directed graph of operations, wherein each of the operations maps to a corresponding execution unit of the processor, and wherein each connection between operations in the directed graph maps to a corresponding storage element of the processor, the task data further defining an operation space representing the dimensions of a multi-dimensional arrangement of the connected operations to be executed.

For each of a plurality of portions of the operation space, the processor is configured to transform the portion of the operation space to generate respective operation-specific local spaces for each of the plurality of the operations of the graph.

The processor is further configured, where necessary, to perform clipping on lower and upper bounds of a task and operation space before running the transform. Clipping may be functionally necessary for the edges of a tensor and allows an operation space which is smaller than a full tensor. An operation space which is smaller than a full tensor is advantageous because it allows a larger sequence of operations to be split across multiple independent tasks and optionally performed on separate cores.

The processor is further configured to dispatch, to each of a plurality of the execution units associated with operations for which transformed local spaces have been generated, invocation data describing the operation-specific local space, and at least one of a source storage element (logically referred to as a source pipe) and a destination storage element (logically referred to as a destination pipe) corresponding to a connection between the particular operation that the execution unit is to execute and a further adjacent operation in the directed graph to which the particular operation is connected.

The present disclosure relates to executing a directed graph of operations (referred to as sections) connected by various connections (referred to as pipes). By providing the capability to operate upon a sequence of connected operations (sections) that can be defined within an operation space common to the sequence of operations, it can be guaranteed that all coordinates required by the operations within the operation space are reachable when executing that sequence of operations. For each execution of an operation (or portion of an operation), the operation space is transformed into a local section space for that operation.

Each operation (section) is linked by corresponding pipes to form a directed graph of operations. For each operation, source and destination pipes can be defined and, under the control of a handling unit, the execution of sections can be issued by issuing invocation data that defines in the source and destination pipes for the operation. This execution of the graph of operation by respective execution units is therefore implicitly ordered by the dependencies on specific inputs to the operation. The result of this implicit ordering being a simplified orchestration of operations amongst the execution units of the processor. Put another way, sections and their directed relationship to each other can be determined by their pipe usage (e.g. their producers/consumers).

In the present disclosure, by transforming from an operation space, there is guaranteed that for each possible operation there is a specific coordinate space referred to as section-space (or section-specific local space). For every operation, there may be a fixed function transform from their individual section-space to each of their input and output data (pipes); this may be different for multiple inputs/output. For element-wise operations, the transform from section-space to input and output pipes will be an identity mapping: no transformation is required. For convolution, the output is similarly the identity of the section-space, with a transform only required to the inputs. An exception to this being that for some operations (e.g. convolution) the output space is only the outer four dimensions. Further, the inputs to some operations may have non-identity transforms from section space and may be different to each other. However, in the present disclosure every operation is defined with its own independent section-space, that is specific to that section (or operation) without needing to map onto the output of other operations.

Different operations having different types are linked together by defining the common operation-space for the whole graph (or progression of operations), and then defining transforms from the operation-space to each operation's individual section-space. Now each hardware unit only needs to understand their fixed-function transform from section-space to input/output spaces, without needing to understand the progression of operations preceding or succeeding it. For example, it is possible to link additional operations in front of or after a convolution operation and stitch a wider variety of operations together, provided that the conditions of a valid operation space exist. Since all sections are iterating through the same operation-space in execution, blocks of data are aligned. For example, a first block from a memory read operation will be the first block into the data processing operation, and this will trickle through to the first block in the memory write operation. This is a simplification given that for some operations (reduction and broadcast operations) since the block may be grouped with data from other blocks to form a new merged block, but generally holds as a principle. Operation-space is typically mapped to a specific operation's space in the graph, with programmatic transforms provided for all other operations.

Operations accessing pipes might have an additional transform to access data stored in pipes. For example, this might be a different transform for the different pipes: different for multiple inputs, different for outputs. This transform is defined in the nature of the operation and is fixed function.

In summary, an operation's section space might be mapped to input and/or output (they can be the same), or operation's section space might be mapped separately in which case a fixed function transform might be needed. In this way, the proposed approach allows for more compartmentalized functionality in separate execution units. The execution units of the processor can therefore be implemented in a more simplified structure since there is no need to provide the capability in each execution unit to perform complex transforms on the front-end or output of the execution units. Instead, the transformation from operation space to section space (and therefore the management of compatibility and correct structuring of data between consecutive operations) is managed and issued centrally by a single handling unit based upon the dimensionality of a pre-defined operation space—e.g. by a descriptor that defines the operation space and the sections and pipes that form the graph.

Since the single transform unit can execute the transforms from operation to section-space, the processor is able to add support for additional operations in the future without the need for significant hardware modification to the execution units to allow additional operations to be linked in front of or in any place in a progression. This allows new functionality to be added easily. As an example: for a convolution operation, dynamic weights can be added easily by adding a data re-ordering unit or transform capable of transforming a tensor in an activation layout into a weight layout, which can be handled by a convolution engine. Attributes of operations such as padding around the edges of an input can also be implemented through the transform mechanism.

Moreover, many less-common operations can be broken down into smaller units of execution (e.g. by simpler fundamental operations from which more complex (or less-common) operations can be constructed). Iteration of more common operations can enable support for larger operations that cannot otherwise be accommodated within the constraints of the processor, rather than implementing native support within an execution unit. For example, for operations convolution operations with a stride value >1 can be implemented by breaking the kernel down into single element increments and iteratively invoking a convolution engine with a 1element kernel, thus making larger strides supported. Similar examples exist for operations that require a dilation value >1. 3D convolution operations can similarly be implemented as iterative 2D convolution operations.

In some examples, the processor is optionally configured such that more than one operation in the directed graph of operations is mapped to the same executing unit of the processor; and more than one connection in the directed graph of operations is respectively mapped to a different portion of the same storage element.

In some examples, the processor is optionally configured such that each execution unit of the plurality of execution units of the processor is configured to perform a specific operation type and wherein the mapping between operations in the directed graph and the execution units is defined based upon compatibility of execution between the operation in directed graph and the specific operation type of the execution unit.

In some examples, the processor is optionally configured such that the task data comprises an element-count value indicating a count of a number of elements mapping to each execution unit having a specific operation type, wherein each element corresponds to an instance of use of an execution unit in order to execute each operation in the directed graph; and a pipe-count value indicating a count of the number of pipes needed to execute the task. There exists an element to describe each type of section and each type of pipe and so an element may be defined as a structured definition of a pipe or section. As described herein, a section has various parameters that describe the specifics of an execution.

In some examples, the processor is optionally configured such that the task data further comprises, for each element in the directed graph, element configuration data defining data used to configure the particular execution unit when executing the operation.

In some examples, the processor is optionally configured such that the element configuration data comprises an offset value pointing to a location in memory of transform data indicating the transform to the portion of the operation space to be performed to generate respective operation-specific local spaces for each of the plurality of the operations of the directed graph.

In some examples, the processor is optionally configured such that the task data comprises transform program data defining a plurality of programs, each program comprising a sequence of instructions selected from a transform instruction set. The processor is optionally configured such that the transform program data is stored for each of a pre-determined set of transforms from which a particular transform is selected to transform the portion of the operation space to generate respective operation-specific local spaces for each of the plurality of the operations of the directed graph.

In some examples, the processor is optionally configured such that the transform program data is configured to perform the particular transform upon a plurality of values stored in boundary registers defining the operation space to generate new values in the boundary registers.

In some examples, the processor is optionally configured to iterate over the operation space in blocks, wherein the blocks are created according to a pre-determined block size.

In some examples, the processor is optionally configured such that dispatch of invocation data is controlled based upon a value identifying the dimensions of the operation space for which changes of coordinate in said dimensions while executing the task causes the operation to execute, and a further value identifying the dimensions of the operation space for which changes of coordinate in said dimensions while executing the task causes the operation to store data in the storage, wherein the stored data being ready to be consumed by an operation.

### Execution of a Directed Graph (DG)

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph is a data structure of operations (herein also referred to as ‘sections’) having directed connections therebetween that indicate a flow of operations. The connections between operations (or sections) present in the graph of operations are also to referred herein as ‘pipes’. A directed graph may contain any number of divergent and convergent branches.

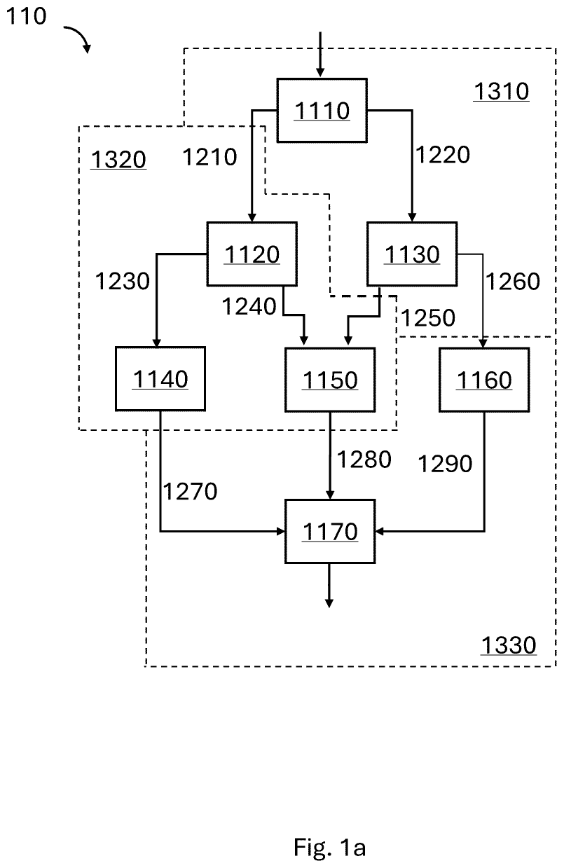

FIG. 1a illustrates an example directed graph in which sections are interconnected by a series of pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe. For example, section 1150 in FIG. 1a receives a first set of input data via pipe 1240 from section 1120 and a second set of input data via pipe 1250. Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 1a illustrates an arrangement where the graph 110 is broken down into three sub-graphs 1310, 1320, and 1330 which can be connected together to form the complete graph. For example, sub-graph 1310 contains sections 1110 and 1130 (as well as the corresponding pipes 1220 and 1260), sub-graph 1320 contains sections 1120, 1140, and 1150 (as well as corresponding pipes 1210, 1230, 1240, and 1250), and sub-graph 1330 contains sections 1160 and 1170 (as well as corresponding pipes 1270, 1280, and 1290).

The deconstruction of a graph 110 into sub-graphs is particularly useful when seeking to execute the graph since it would be possible to separately execute the sub-graphs which allows for parallelization of execution where there are no dependencies between sub-graphs. This can be particularly useful in a multi-processor environment where sub-graphs can be allocated for execution by different processors in the multi-processor environment. However, as shown in FIG. 1a sub-graph 1320 has a dependency on the execution of operation A and section 1110 and sub-graph 1330 has a dependency on sub-graph 1310. As such, execution of sub-graph 1330 may need to be stalled until sub-graph 1310 has been completed. It will therefore be appreciated that it is necessary to carefully select the appropriate sub-graph arrangement to maximize or improve the execution efficiency of the graph.

The operations performed when executing a neural network can be broken down into a sequence of operations forming a directed graph in the form described in respect of FIG. 1a. The detailed description herein will describe an arrangement for executing a directed graph of operations in an improved manner.

### Operation Space

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed. The possible set of operations from which sections can be formed can be hard to manage when seeking to design hardware to enable the execution (also referred to as “acceleration”) of these operations—particularly when linked together. For example, enabling fixed-function operation of each possible type of operation can result in inefficient hardware by requiring support for obscure or complex operations (sections).

As a result, there are significant challenges in designing and building hardware capable of executing all types of neural networks created by the current machine learning toolsets. It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

However, even with such operator sets existing, there is a need to implement the operator sets in a manner that can be executed efficiently, both in terms of complexity and while minimizing the need to perform external memory transactions. To enable this, it is useful to consider that many of the operations in a defined operation set (such as TOSA) can be represented as a loop of scalar operations.

For example, consider a 2D convolution operation which can be expressed as a multi-dimensional loop of scalar operations. These may need to be executed on input 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For the 2D convolution operation example above, it is possible to express the operation to be performed as a “nested for-loop” of scalar operations as is illustrated in the pseudocode set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

The seven dimensions of the convolution operation can collectively be used to define the ‘operation space’ in which the 2D convolution operation is to be performed. More specifically, the sizes of each dimension can be used to define an effective “bounding box” defining the size, the number of elements in each dimension, of the operation space upon which the operation is to be performed. To illustrate this in more detail, consider an example where a 3×3 (i.e. KX=3; KY=3) convolution operation having padding is to be performed on input data having dimension IX=15; IY=15; N=1; and IC=32. This operation results in the following minimum and maximum index values representing the upper and lower bounds inclusive (i.e. the size) of the dimensionality of the convolution operation as shown in Table 1:

TABLE 1

| | OC | N | OY | OX | IC | KY | KX |
|---|---|---|---|---|---|---|---|
| Min | 0 | 0 | 0 | 0 | 0 | 0 | 0 |
| Max | 63 | 0 | 14 | 14 | 31 | 2 | 2 |

The output of the 2D convolution operation would have dimensions N=1; OY=15; OX=15; OC=64. These values represent the size of the output of the 2D convolution operation but they do not alone wholly represent the size of the operation required to generate that output. To wholly represent the operation space of the operation, all the dimensions of the operation are required as shown in the above table. A shorthand representation for the dimensions of the 2D convolution operation is [OC N OY OX IC KY KX] and in this specific example can be presented as the minimum and maximum index values as illustrated in the example above i.e. [64 1 15 15 32 3 3].

Operations such as the convolution operation described above can be separated into blocks, each block representing a subset of an operation in which each dimension of the block covers a subset of the full range of the corresponding dimension in the operation. In the example below, the 2D convolution of Table 1 is separated into multiple blocks by breaking up the operation in the OY, OX, and IC dimensions. Breaking the operation into blocks involves separating the operation space of the operation into multiple blocks which each individually represent a portion of the operation but collectively represent the operation space. This block generation involves separating the operation space into sub-blocks representing a non-overlapping subset of the dimensions in the operation space which wholly cover the operation space dimensions (e.g. the set of nested for-loops shown above). In an example where the operation is to be separated into a number of blocks, the operation space is broken down into sub-blocks based upon a pre-determined block-size which defines for each dimension of the operation a fixed size. This fixed size block is referred to herein as a block quantum. In the example below, the block size is as follows:

TABLE 2

| | OC | N | OY | OX | IC | KY | KX |
|---|---|---|---|---|---|---|---|
| Block | 16 | 1 | 8 | 8 | 16 | 3 | 3 |
| quantum | | | | | | | |

In the block size above, the operation space is broken up by separating four of the seven dimensions of the operation in two. In the examples below, OY, OX, and IC have been separated into two, while OC has been separated into four. The following blocks illustrate a portion of the blocks that wholly represent the operation space (with only a first quarter of the OC dimension being represented):

TABLE 3

| | OC | N | OY | OX | IC | KY | KX |
|---|---|---|---|---|---|---|---|
| Block #0 | | | | | | | |
| Min | 0 | 0 | 0 | 0 | 0 | 0 | 0 |
| Max | 15 | 0 | 7 | 7 | 15 | 2 | 2 |
| Block #1 | | | | | | | |
| Min | 0 | 0 | 0 | 0 | 16 | 0 | 0 |
| Max | 15 | 0 | 7 | 7 | 31 | 2 | 2 |
| Block #2 | | | | | | | |
| Min | 0 | 0 | 0 | 8 | 0 | 0 | 0 |
| Max | 15 | 0 | 7 | 14 | 15 | 2 | 2 |
| Block #3 | | | | | | | |
| Min | 0 | 0 | 0 | 8 | 16 | 0 | 0 |
| Max | 15 | 0 | 7 | 14 | 31 | 2 | 2 |
| Block #4 | | | | | | | |
| Min | 0 | 0 | 8 | 0 | 0 | 0 | 0 |
| Max | 15 | 0 | 14 | 7 | 15 | 2 | 2 |
| Block #5 | | | | | | | |
| Min | 0 | 0 | 8 | 0 | 16 | 0 | 0 |
| Max | 15 | 0 | 14 | 7 | 31 | 2 | 2 |
| Block #6 | | | | | | | |
| Min | 0 | 0 | 8 | 8 | 0 | 0 | 0 |
| Max | 15 | 0 | 14 | 14 | 15 | 2 | 2 |
| Block #7 | | | | | | | |
| Min | 0 | 0 | 8 | 8 | 16 | 0 | 0 |
| Max | 15 | 0 | 14 | 14 | 31 | 2 | 2 |

For a given block of the operation space, e.g. [OC N OY OX IC KY KX], it is possible to determine which input feature map coordinates are required to perform the operation for that block. In the example of the 2D convolution operation, the input feature map coordinates (and other input parameters) upon which the output feature map coordinates depend can be defined as the below (stride X, Y=1 (i.e. no striding); dilation X, Y=1 (i.e. no dilation) and top, left pad=1 (i.e. the input is padded):

$$N = N ; ( wherein N is batch number ) ;$$

$$IY = ( OY * ( Stride Y ) ) + ( ( Dilation Y ) * KY ) - Top Pad ;$$

$$IX ; ( OX * ( Stride X ) ) + ( ( Dilation X ) * KX ) - Left Pad ; and$$

$$IC = IC ;$$

Where Stride X and Stride Y, Dilation X, and Dilation Y represent the respective stride and dilation values in X and Y dimensions when executing the convolution operation, and where Top Pad and Left Pad represent respective top and left padding values when executing the operation. When the above relationships are simplified for stride and dilation values of 1 with zero padding, this can more simply be expressed as [N, OY+KY−1, OX+KX−1, IC]. These expressions for calculating the input feature maps for processing a block can be represented as an affine transform as set out below in table 4:

TABLE 4

| | OC | N | OY | OX | IC | KY | KX | Offset |
|---|---|---|---|---|---|---|---|---|
| N | | 1 | | | | | | |
| IY | | | 1 | | | 1 | | −1 |
| IX | | | | 1 | | | 1 | −1 |
| IC | | | | | 1 | | | |
| | | | | | | | | 1 |

For a given block in operation space it is therefore possible to express a transform (an affine or semi-affine transform) to transform the block to determine the input feature map coordinate ranges needed for performing the operation as defined by the block. In the example of the above affine transform being applied to Block #2, the resultant input range of input feature map indexes can be shown to be as below in Table 5:

TABLE 5

| | Min | Max |
|---|---|---|
| N | 0 | 0 |
| IY | −1 | 8 |
| IX | 7 | 15 |
| IC | 0 | 15 |

The affine transform defined above can be used to separately represent the transforms required to define each of the input feature map (as set out above), the output feature map, and the weights. General examples of each of input feature map, output feature map, and weight transforms is set out in Tables 6 to 8 below:

TABLE 6
Input transform for 2D convolution

| IFM | OC | N | OY | OX | IC | KY | KX | Offset |
|---|---|---|---|---|---|---|---|---|
| N | | | | | | | | |
| IY | | | Stride Y | | | Dilation | | Top Pad |
| | | | | | | Y | | |
| IX | | | | Stride X | | | Dilation | Left Pad |
| | | | | | | | X | |
| IC | | | | | 1 | | | |
| | | | | | | | | 1 |

TABLE 7
Weight transform for 2D convolution

| | | | | | | | | |
|---|---|---|---|---|---|---|---|---|
| Weights | OC | N | OY | OX | IC | KY | KX | Offset |

| | | | | | |
|---|---|---|---|---|---|
| OC | 1 | | | | |
| KY | | | 1 | | |
| KX | | | | 1 | |
| IC | | 1 | | | |
| | | | | | 1 |

TABLE 8
Output transform for 2D convolution

| | | | | | | | | |
|---|---|---|---|---|---|---|---|---|
| OFM | OC | N | OY | OX | IC | KY | KX | Offset |

| | | | | | |
|---|---|---|---|---|---|
| N | | 1 | | | |
| OY | | | 1 | | |
| OX | | | | 1 | |
| OC | 1 | | | | |
| | | | | | 1 |

It will be appreciated therefore that the operation space defines the dimensionality of the operations to be performed when executing a particular operation. The above examples are provided in respect of a 2D convolution but the concept is applicable to all types of operation that is to be performed. For example, similar transforms for the input and output of a transpose operation (e.g. transposing dimensions {0,1,3,2}) can be derived as set out below:

TABLE 9
Input transform for {0, 1, 3, 2} transpose

| Input | Dim 0 | Dim 1 | Dim 2 | Dim 3 | Offset |
|---|---|---|---|---|---|
| Dim 0 | 1 | | | | |
| Dim 1 | | 1 | | | |
| Dim 2 | | | | 1 | |
| Dim 3 | | | 1 | | |
| | | | | | 1 |

TABLE 10
Output transform for {0, 1, 3, 2} transpose

| Output | Dim 0 | Dim 1 | Dim 2 | Dim 3 | Offset |
|---|---|---|---|---|---|
| Dim 0 | 1 | | | | |
| Dim 1 | | 1 | | | |
| Dim 2 | | | 1 | | |
| Dim 3 | | | | 1 | |
| | | | | | 1 |

Utilizing the input transform on the input allows the swapping of dimensions 2 and 3 in the input transform matrix to perform the transpose operation. More generally, the input and output matrices can then be applied to a block in operation space to determine a range of values for the input and output of that operation. These determined ranges of values represent the local section space for that operation, which forms a local coordinate system on which that operation can be executed for that block of the operation space.

Clipping on lower and upper bounds of a task and operation space may be implemented before running the transform. Clipping may be functionally necessary for the edges of a tensor and allows an operation space which is smaller than a full tensor. An operation space which is smaller than a full tensor is advantageous because it allows a larger sequence of operations to be split across multiple independent tasks and optionally performed on separate cores.

In such a clipping model, code may be used to initialize the upper/lower bounds before performing the transform, where low=op_space; high=op_space and the initial coordinates are op_space+block_size−1, by default. The coordinates are clipped to the actual operation space and task bounds before transformation occurs.

When considering the directed graph data structure described above in respect of FIG. 1a, the operation performed in each section of the graph can be defined by the set of input and output transform matrices for that operation. It is therefore possible to represent at least a portion of the directed graph by a progression of operations that correspond to a progression of sections each connected by pipes. In addition, an operation space for a progression of operations can be established.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 1a.

FIG. 1b shows schematically an example of a data processing system 600 including processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g. such that at least some functional units and resource of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this document. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data use for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced eXtensible Interface (AXI), may be used.

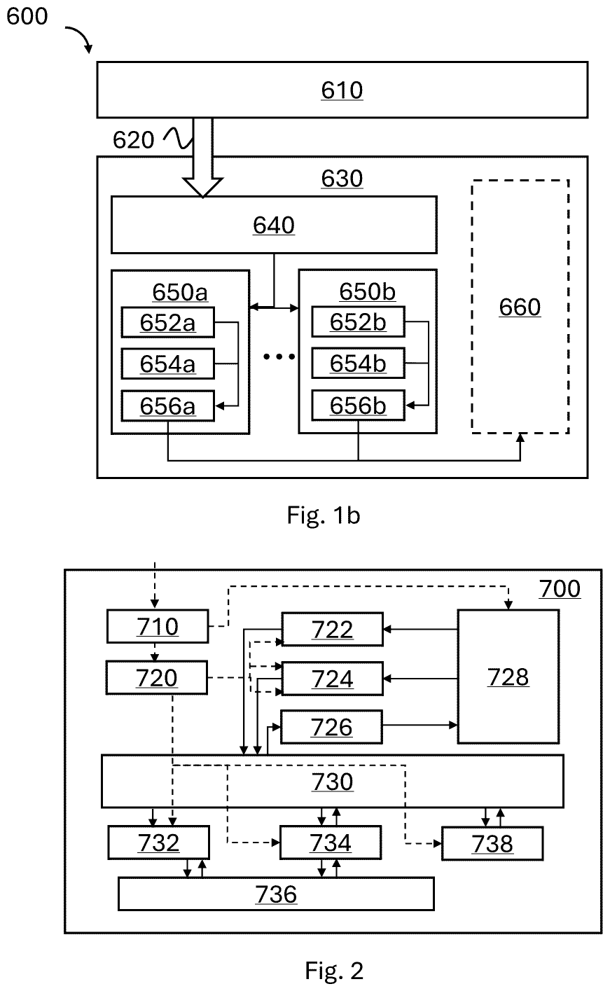

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a shared storage 738, for processing of blocks of data. The data dependencies across the functional units are tracked by the handling unit 720. Processing is initiated by the handling unit 720 in a functional unit if all input blocks are available and space is available in the shared storage 738 of the neural engine 700. The shared storage 738 may be considered to be a shared buffer, in that various functional units of the neural engine 700 share access to the shared storage 738.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the directed graph representing the neural network are also referred to as pipes within the context of the directed graph. These pipes can also be mapped to the uniquely identified physical storage elements in the neural engine. For example, the accumulator buffer 736 and shared storage 738 (and portions thereof) can each be regarded as a storage element that can act to store data for a pipe within the directed graph. The pipes act as connections between the sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe.

The weight fetch unit 722 fetches weights associated with the neural network from external storage and stores the weights in the shared storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the directed graph. The result of each operation is stored in a specific pipe within the neural engine 700. The DPU array 730 is arranged to perform one or more operations associated with a dot product operation between two operands, such as between an array of weights and a corresponding block of data (e.g. representing part of a tensor). As will be described in further detail below, the vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary storage in the accumulator buffer 736 which acts as a pipe between the previous operation and the subsequent operation, from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data from a pipe, such as shared storage 738 (e.g. after processing by the DPU array 730 and/or vector engine 732), and writes transformed data back to the shared storage 738.

To make efficient use of the shared storage 738 available within the neural engine 700, the handling unit 720 determines an available portion of the shared storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the shared storage 738 corresponding to the available portion. The logical address is for example a global address in a global coordinate system. Hence, by altering the physical address corresponding to a given logical address, the handling unit 720 can effectively control usage of the shared storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes.

All storage in the neural engine 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 700.

Ordering of execution of the sections is implied by dependencies on inputs. A memory load operation has no data dependencies (unless it is a gather operation), so is implicitly early in the graph. The consumer of the pipe that the memory read produces is implicitly after the memory read. A memory store operation is near the end of the graph, as it produces no pipes for other operations to consume. The sequence of execution of a progression of operations is therefore handled by the handling unit 720 as will be explained in more detail later.

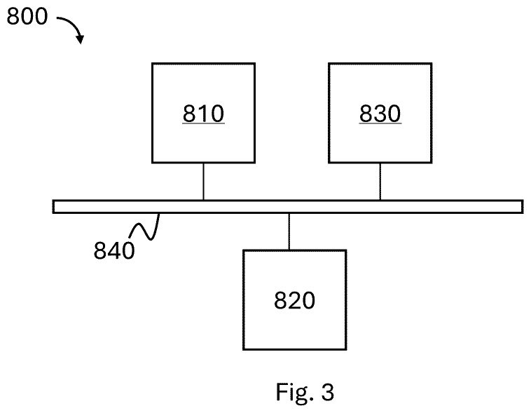

FIG. 3 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 1b and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBA®) interface, such as the Advanced eXtensible Interface (AXI), may be used.

### Neural Engine Program Descriptor (NED)

The neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issues by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes. In one implementation, each of the execution units and each storage element (or portion of a storage element) of the neural engine 700 has a sub-descriptor definition which defines how that execution unit/storage element can be configured for use in implementing a specific section or pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes, which are described in another element as part of the NED: NEDPipeElement. Pipes are used to represent data storage elements within the neural engine 700 and describe the relationship between sections (operations) in a producer-consumer relationship: the output destination pipe (e.g. a pipe number) and each input source pipe (e.g. a pipe number) for every section is defined in the NED elements of the NED. A pipe has only a single producer but may have multiple consumers. A pipe may be mapped to one of several different locations (e.g. storage elements in the neural engine 700), but not all locations may be suitable for the different section operations. It will be appreciated that, in some arrangements, a pipe may be mapped to only a portion of a storage element—e.g. a number of physical buffers, allowing it to describe double-buffering (for example) behavior between its producer and consumers. The output data generated by a section and stored in a pipe is referred to equivalently as both a block (of data) and a (virtual) buffer, with a block of data occupying one physical buffer location. Irrespective of location, pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input.

In some embodiments, sections such as InputReader and WeightFetcher have no pipes and instead their data comes from external memory, such as an external cache or DRAM. By contrast, some sections, such as OutputWriter have no output pipes. In this case, their data is written to external memory.

For a section to run, it must have all the appropriate buffers available for its input source pipes. A section may produce a new buffer in its output destination pipe and so there must be space available in the pipe for this new buffer. In the case of a reduction operation (convolution, for example), a section may repeatedly read back and update the previous buffer it generated. As a result, for a reduction operation there is a distinction between the reduction operation having first generated the output buffer and the reduction having completed and the output buffer being fully available, due to this update process. Put another way, there is a point in time at which the output buffer exists in the input pipe of a subsequent operation, but it is not yet ready to be consumed by the subsequent operation. The neural engine 700 is responsible for tracking all of these dependencies, in which buffers are tracked like FIFO entries, but with buffers only available for consumers when a producer has completed any sequence of reductions, and with buffers only freed up when all consumers have completed operations dependent on them.

A task's graph has a directed dataflow. A reduction operation will both read from and write to their output destination pipe's buffer. For example, the convolution engine may repeatedly accumulate into the same accumulator buffer.

In this example implementation, the neural engine is stateless between tasks: all control state is encapsulated in the task's NED, and all data is encapsulated in the pipes defined by the NED. There is no sharing of pipes between tasks and therefore no architected sharing of data between tasks within the neural engine 700. Data reuse and sharing is achieved only through memory by use of the Output Writer in a preceding task and the Input Reader in a later task. The neural engine will cache memory descriptors, including the NED, between tasks; this cache is invalidated each time a complete neural workload is completed (e.g. the total neural network and not just the sub-graph associated with a specific task). However, it will be appreciated that this is just an example implementation.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header to represent the hardware requirements needed to invoke execution of the graph. For example, for a section that defines a convolution operation, a corresponding configuration and invocation of a convolution engine execution unit would be required. Similar counts of instantiations of weight fetch and input read execution units is counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

TABLE 11

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode sections | 0 | 1 |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D—namely [oc, n, oy, ox, ic, ky, kx].

TABLE 12
Field

Stride X and Stride Y
Dilation X and Dilation Y
Operation type (e.g. which type of
convolution operation is to be performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

TABLE 13

| Field | Min | Max |
|---|---|---|
| Pipe location (e.g. accumulator | 0 | 2 |
| buffer, shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

As will be described in more detail later, these descriptors are used to configure the hardware elements when invocation is triggered by the handling unit 720.

### Neural Engine Dimensions and Iteration

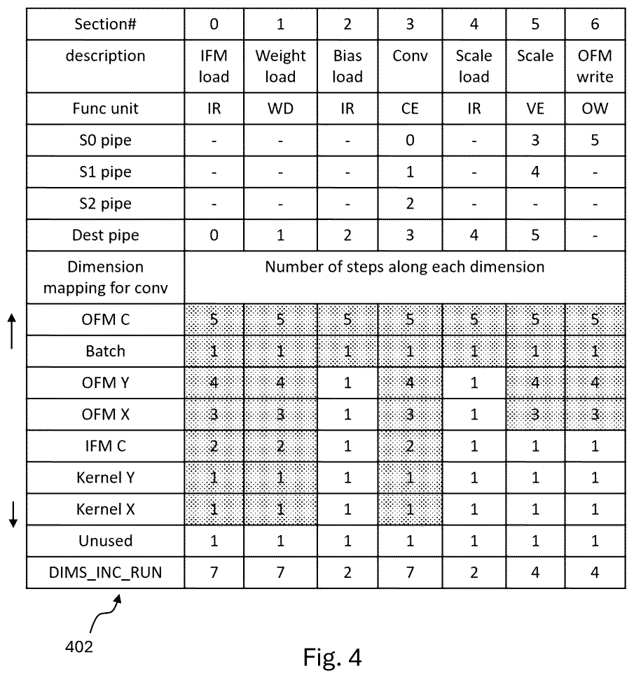

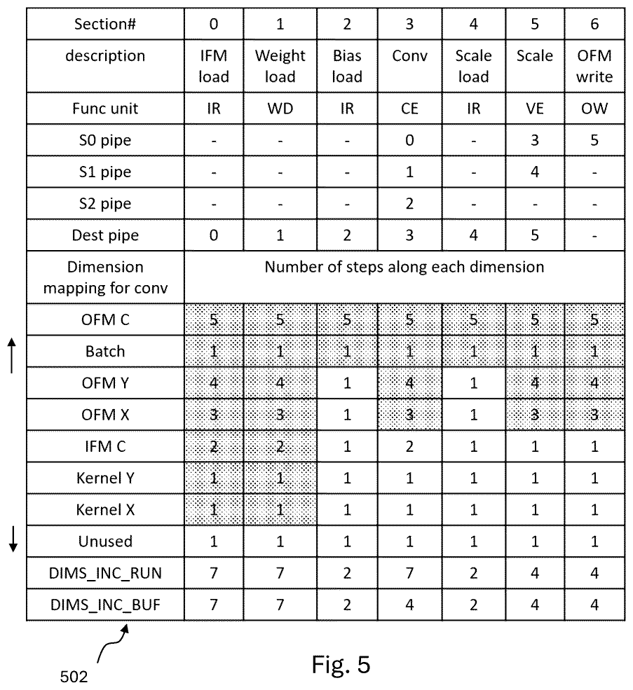

A neural engine task describes a 4D bounding box (dimensions #0-3) that should be operated on by the section operations of a graph defined by a NED that the task provides a pointer to. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions. As illustrated in FIGS. 4 and 5, the command processing unit 640 may issue different tasks to different neural engines. As such, the dimensions 0-3 when the NED is generated or at the point that the task is defined. The latter four dimensions are described in their entirety in the NED and are therefore covered entirely in each task. The NED additionally defines an increment size for each of these 8 dimensions to be stepped through, known as a block size. Execution of the graph against this 8D operation-space can be considered as a series of nested loops.

This splits the execution of the task's operation-space into a series of blocks, with sections being invoked on a block-by-block basis, operating on a block's worth of data in every source and destination pipe. Consequently, defining a general operation space in a coordinate system having for example eight dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to link a plurality of operations to be executed on data to each other and coordinate execution of these functions. Operation space dimensions does not have a specific interpretation until they are projected into space for a specific task.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions. This relationship is described by two variables, the number of operation-space dimensions triggering increments for each section, dims_inc_run (a “dimensions increment run” value), and the number of operation-space dimensions generating new blocks for each pipe, “dims_inc_buf” (a “dimensions increment buffer” value), both of which are encoded in their respective NED elements. Both fields are specified counting dimensions from the outer-most dimension #0 up to the inner-most dimension #7.

dims_inc_run specifies how many operation-space dimensions trigger invocations of the section when those dimensions increment in operation-space. Example usage of dims_inc_run is illustrated below:
0: the section is independent of the operation-space and will therefore only be invoked once for the task;
1: the section may depend on operation-space dimension #0, and is invoked for each operation-space step through dimension #0; and
8: the section may depend on all operation-space dimensions, and is invoked for each operation-space step.

dims_inc_buf specifies how many operation-space dimensions generate a new block in the pipe when those dimensions increment in the producer section, effectively defining how many blocks the pipe generates throughout the duration of the task.

If the value of dims_inc_buf is k (where k>0), then pipe.blocks=dim[0].blocks*dim[1].blocks* . . . *dim[k−1].blocks whereas if the value of dims_inc_buf is k (where k==0), then the pipe only ever has a single block.

For simple operations, dims_inc_run will be equal to dims_inc_buf for all source input and output destination pipes, but for more complex operations, dims_inc_run may be greater.

Where dims_inc_run>dims_inc_buf for a source pipe: this relationship between the fields indicates the reuse of a buffer through one or more operation-space dimensions, the difference between the two values specifying the number of reuse dimensions. In this context, reuse means that the data is broadcast through the extra dimensions i.e. the buffer in the Neural Engine's internal memory is consumed multiple times. For example, the feature map input to a convolution operation is typically reused against the weight kernel x and y dimensions of the convolution engine.

Meanwhile, for a destination pipe, dims_inc_run>dims_inc_buf indicates the reduction of one or more operation-space dimensions' set of buffers, the difference between the two values specifying the number of reduction dimensions. In this context, reduction means that the data from the extra inner operation-space dimensions are accumulated in the smaller number of outer operation-space dimensions (with the section reading back and updating its output buffer over multiple invocations). For example, a vector block reduction operation will result in a smaller number of buffer increments.

Where a pipe has multiple consumers, there is no relationship between those consumers and no restriction or requirement on the value of dims_inc_run for a consumer with respect to other consumers.

In the examples described herein, the neural engine's handling unit is responsible for iterating through this 8D operation-space for each section described in the NED graph. The handling unit uses the two values, dims_inc_run and dims_inc_buf, to determine which increments are relevant and to correctly manage the dependencies between the sections and their pipes. Each section operates in its own local coordinate space, known as the section-space, and the handling is responsible for transforming each relevant operation-space block (relevant through an increment in a run dimension) into this section-space. In the examples described herein, this transformation may be programmatic and described with a small program in a specialized (or general purpose) ISA that is executed for each block before the section is invoked.

The handling unit may be synchronizing the execution of multiple different parts of these nested for-loops in parallel, and therefore needs to track where in the loop a function of a component should be invoked, and where in the loop, data that may be needed by subsequent components (based on the partially ordered set of data structures) is produced. To achieve this in a flexible way, which still allows for a straightforward hardware implementation, two types of dimensions are specified in each data structure.

In some embodiments, each data structure comprises N vectors of binary values indicating, for each of the N dimensions of the coordinates space, whether changes of coordinate in said dimensions while executing the task causes the function of the associated component to execute or not and causes the function of the associated component to store data in the storage or not (DIMS_INC_RUN). Effectively, this allows for the behavior of each component for each dimension to be encoded as a multi-hot vector of behaviors. Behaviors may include for example reuse, recompute, reduce, output, unmapped/once.

In some types of tasks including operations on data, data is frequently “reused” multiple times over some number of dimensions. For example, in operations in a neural network, same weights may be applied to multiple elements in the Batch, X and Y dimensions of a feature map, but the weights are unique over the input and output channel dimensions. To inform the handling unit about the specifics of each function (based on the task at hand), each data structure may indicate the dimensions of the coordinates space for which changes of coordinate in said dimensions while executing the task causes the function of the associated component to execute.

To save bits and reduce complexity, each data structure may instead comprise a first number 402 (as well as a second number described further below in conjunction with FIG. 5) indicating the dimensions of the coordinate space for which changes of coordinate in said dimensions while executing the task causes the function of the associated component to execute, such as a number between 0 and N (number of dimensions in operation space, eight in the example of FIG. 4). In case the number is equal to 0 the section is invoked once per task (e.g., when the iteration over the N=>1 dimensional coordinate space starts or ends). This may for example correspond to a function that loads a table to be used in subsequent sub-tasks no matter of coordinate or dimension. In the opposite extreme, the value could be equal to N, which means the function of the component is executed on every iteration of every dimension.

In FIG. 4, shaded elements correspond to dimensions (for each section) for which changes of the coordinate causes the function to execute (e.g. DIMS_INC_RUN). As can be seen in FIG. 4, for the data structures described as “IFM load”, “weight load” and “conv”, the function associated with the respective component is executed when any dimension increments. “Bias” and “scale load” are only invoked (executed) when Batch or OFM channel increment. “Scale” and “OFM write” sections are invoked when Batch, OFM C, OFM Y or OFM X increment.

In some types of tasks including operations on data, the function executed on the data may result in a fewer number of dimensions being output. For example, as can be seen in FIG. 4, a 2D convolution operation (conv) iterates over batch (N), output feature map height (OFM Y), output feature map width (OFM X), input channels (IFM C), output channels (OFM C), kernel X (KX), and kernel Y (KY). However, it reduces these seven dimensions down to four at its output (N, OFM X, OFM Y, OFM C). Similarly, a so-called “reduction operator” such as ReduceSum iterates over a tensor and sums the data across one or more dimensions, producing an output tensor with fewer dimensions than the input tensor. To inform the handling unit about the specifics of each function (based on the task at hand), each data structure may indicate the dimensions of the coordinate space for which changes of coordinate in said dimensions while executing the task causes the function of the associated component to store data in the storage, wherein the stored data being ready to be consumed by a function of a component associated with a subsequent data structure in the partially ordered set of data structures or to store final output data for the task. Put differently, when such dimension increments (i.e., the coordinate changes), a new buffer is available in the pipe to be used by a function of a component associated with a subsequent data structure in the partially ordered set of data structures, or final data for the task (i.e., for the part of the bounding box currently being processed) being stored in an output buffer.

In some embodiments, each section comprises N dimension specifications, indicating, for each of the N dimensions of the coordinates space, implications on storage for each dimension when a coordinate in said dimensions changes while executing. To save bits and reduce complexity, each data structure may instead comprise a second number indicating the dimensions of the coordinate space for which changes of coordinate in said dimensions while executing the task causes the function of the associated component to store data in the storage, the stored data being ready to be consumed by a function of a component associated with a subsequent data structure in the partially ordered set of data structures or to store final output data for the task. The second number (reference 502 in FIG. 5) may be a number between 0 and N (number of dimensions in operation space, eight in the example of FIG. 4). Since the storage of data may only take place when the function of the associated component executes, the second number may be equal or less than the first number.

The second number being 0 indicates that the section (data structure) produces exactly one block of output ready to be consumed by a function of a component associated with a subsequent data structure/section. The second number being 1 indicates that the section produces output (ready to be consumed) only when operation space dimension 0 increments (coordinate changes). The second number being 2 indicates that the section produces output (ready to be consumed) when either operation space dimensions 0 or 1 increment, etc. In case the second number is less than the first number, this indicates a reduction operation.

In FIG. 5, shaded elements correspond to dimensions (for each data structure) for which changes of the coordinate causes the function of the associated component to store data in the storage (in contrast to FIG. 4 which relates to causing a function to execute—e.g. DIMS_INC_BUF). The stored data is ready to be consumed by a function of a component associated with a subsequent data structure in the partially ordered set of data structures, or is final output data for the task. As can be seen in FIG. 5, for the data structures described as “IFM load” and “Weight load”, the function associated with the respective component stores data being ready to be consumed by a function of a component associated with a subsequent data structure in the partially ordered set of data structures when any dimension increments. “Bias” and “Scale load” only store data ready to be consumed by a subsequent function when Batch or OFM channel increment. “Scale” stores data ready to be consumed by a subsequent function when Batch, OFM C, OFM Y or OFM X increment. “OFM write” stores final output data for the task when Batch, OFM C, OFM Y or OFM X increment. “Conv”, IFM C, Kernel X and Kernel Y are marked as dimensions where the associated function will execute (see FIG. 4), but not as dimensions which causes the associated function to store data ready to be consumed. This means that these three dimensions are so called reduction dimensions, and seven dimensions are reduced to four at the output of Conv.

In examples, if an operation space dimension is marked (FIG. 4) as a dimension for which changes of coordinate in said dimensions causes the function of the associated component to execute but not marked (FIG. 5) as a dimension for which changes of the coordinate causes the function of the component that generates the input buffer for the associated component to store data in the storage, this indicates reuse of an input buffer by the executing section. For example, if we have sections A->B and the storage dimensions for A is less than the run dimensions for B then there is reuse by B of the input buffer that was written by A. On the other hand, if the storage dimensions of B are less than the execute dimensions of B, then that is reduction by B onto the output buffer.

The data structure described may be generated by e.g., a compiler connected to the processor, wherein the complier is configured to generate code for the processor to execute. The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section-space before invoking the section's execution unit with the transformed block by issuing invocation data.

In general, for most cases, these two processes are defined in the examples described herein to be architecturally independent. This means that the execution of any given block is defined definitively and completely in itself, in isolation of any other block or the state of the handling unit operation-space iteration. The execution of blocks that are not in accordance with this operation-space iteration and transformation will run to completion, but the output will not provide meaningful results with respect to the full operation definitions of the Tensor Operator Set Architecture.

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access but must not extend beyond the size of a pipe's buffer or the total size of a tensor. When the section-space is smaller than the pipe buffer, VE BlockReduce operations have an additional requirement to not modify the data in the buffer beyond the section space; no other operations or execution units have this requirement.

The TSU operation-space iteration may generate a block with one or more execution dimensions that are zero (execution_dimension_empty), meaning that no functional operation is required; this may occur due to padding before the start of operation-space or clipping at the end of operation-space, for example. As noted in TSU task iteration and block invocation, the block must still be dispatched to the execution unit for correct tracking of dependencies and execution ordering.

In this way, the following must hold for a transform to be valid for an operation-space to section-space transform to be compatible when connected by a pipe.

Assume the following scenario:
section S0 writes to a pipe P;
section S1 reads from the same pipe P;
T0( ) is the transform for section S0;
T1( ) is the transform for section S1;
B is a block in operation-space;
B0 is the absolute tensor coordinates of the block written to pipe P by S0;
This will be DST(T0(B)) where DST( ) is the fixed transform for S0's execution unit to its destination output space;
B1 is the absolute tensor coordinates of the block read from pipe P by S1;
This will be SRC(T1(B)) where SRC(is the fixed transform from S1's execution unit to its source input space;

Then the following must hold:
Compatible origin: Block B0 and block B1 must have the same lower bound coordinate for each dimension;
This coordinate forms the origin of the block stored in the pipe buffer;
Sufficient size: The size of block B0 must be greater or equal to the size of block B1 for each dimension;
The operation-space iteration may generate a block with one or more execution dimensions that are zero, meaning that no functional operation is required; this may occur due to padding before the start of operation-space or clipping at the end of operation-space, for example. The block must still be dispatched to the execution unit for correct tracking of dependencies and execution ordering.

To implement a reduction operation, the operation-space iteration will issue a sequence of block invocations to an execution unit (e.g. the convolution engine or vector engine) all targeting the same output block. The handling unit will signal when executing the first block in this sequence, and the execution unit must start by initializing the destination buffer (the whole buffer as limited by the block's size as described above), whereas for all subsequent blocks in the sequence the unit will read back the existing values from the buffer. In this way, the destination buffer acts as an additional input to the operation, from the perspective of individual block execution. In the case of the convolution engine, it is possible that one or more reduction dimensions are zero, meaning that no functional operation is required, but the convolution engine must still initialize the destination buffer if it is the first block in the sequence and the block's execution dimensions aren't empty.

When the handling unit invokes an execution unit to execute a block, the handling unit is configured to issue invocation data to execute the operation on a block. The block iteration is defined based on a block size specified in the NED and the issuance of the invocation data is done under the control of the DIMS_INC_RUN value as discussed above. Moreover, it is necessary for any dependencies that need to be met for the execution unit to operate on the block. These include that the required data is stored in the source pipe(s) for the operation and that sufficient storage is available in the destination pipe, as well as that the transform of the operation space to section space for that section has been performed and the output of that transform operation (i.e. the transformed coordinate data) is available to be issued to the execution unit. More specifically, it is to be ensured that there is sufficient availability in the pipe for a new block or buffer. However, this is not needed if this is not the first step in a reduction block, because in this instance the operation may involve simply read-modify-writing a previous destination block/buffer. Determining the availability of a source storage element may involve determining there is an appropriate block/buffer in the source pipe.

In an example, the invocation data comprises the output of the transform program in the form of transformed coordinates along with the relevant parts of the NED that describe that section (e.g. the configuration data from the sub-descriptor element of the NED for that section). This additional configuration data may also include the type of operation being performed (where the execution unit is able to perform more than one type of operation) and any other attributes of the operation, such as stride and dilation values in the example of a convolution operation.

The iteration process first involves reading from the NED a block size and iterating through the operation space one block at a time. For each block, a transform program is executed to transform the operation space coordinates to section space coordinates for that section. More detail on the transform programs is set out below. Once the section space coordinates have been determined, the section operation is performed in respect of that block. This process is iterated over all blocks until the operation is completed for all blocks.

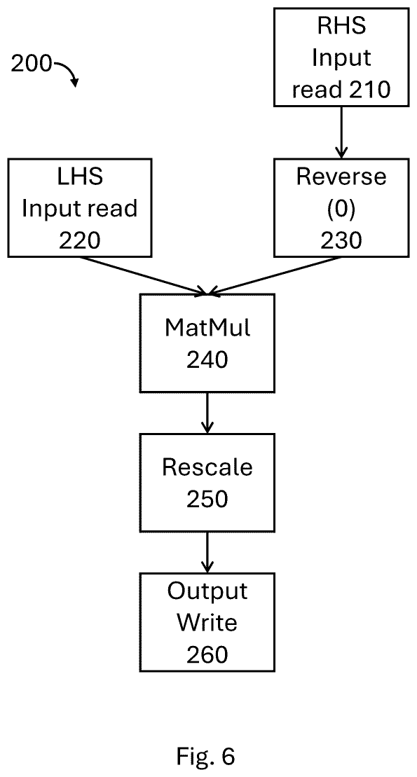

FIG. 6 illustrates an example progression 200 of operations to be performed. The progression comprises a left-hand-side (LHS) input read operation 220 and a right-hand-side (RHS) input read operation 210. The output of the RHS input read operation 210 is input into a Reverse operation 230 which in turn is output, along with the output of the LHS Input Read operation 220 into a Matrix Multiplication (MatMul) operation 240. The output of the MatMul 240 operation is input into a Rescale operation 250, the output if which is provided to an Output Write operation 260 that writes the output to memory.

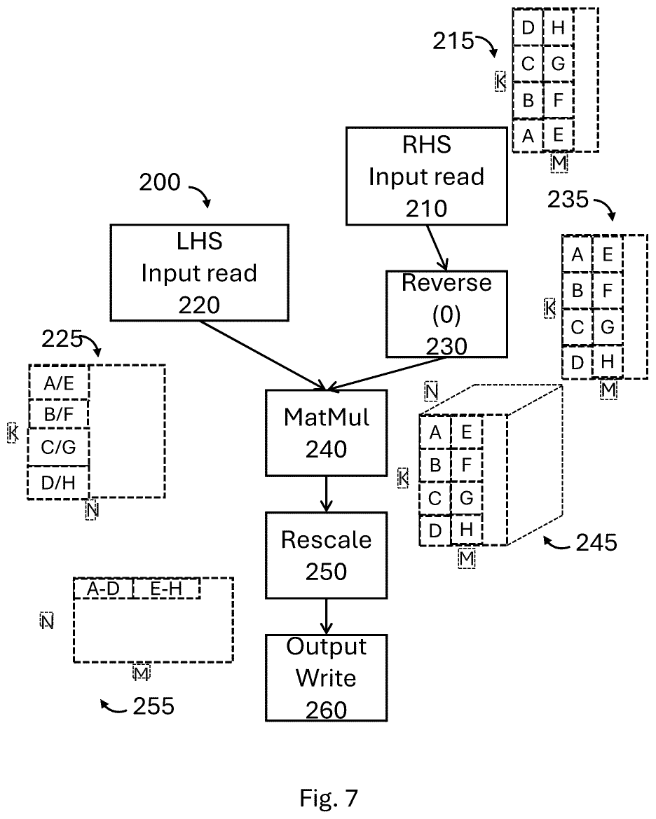

FIG. 7 illustrates the corresponding coordinate space (i.e. the section space for each of the operations). For example, the RHS Input Read section space 215 is illustrated for the RHS Input Read 210 operation. The LHS Input Read section space 225 is illustrated for the LHS Input Read operation 220. The Reverse section space 235 is illustrated for the Reverse operation 230. The MatMul section space 245 is illustrated for the MatMul operation 240. The Rescale section space 255 is illustrated for the Rescale operation 250. In this example, the section space for the Output Write operation is illustrated using the section space 255 since this is unchanged from the section space for the Rescale operation.

Each section space comprises a plurality of dimensions—namely two dimensions (e.g. K,N; K,M). The section space is separated into blocks having a pre-defined block size—with each of blocks A to H representing a different block to be operated on in line with the examples set out herein.

As can be seen, the Reverse section space 230 has a dimensionality which is effectively reversed with respect to the RHS Input Read section space 215. Section space 225 for the LHS Input Read contains blocks A/E, B/F, C/G, D/H which are repeated. The section space 255 for the Rescale and Output Write operation contains two blocks, A-D and E-H. This is because the MatMul operation is a reduction operation. In the MatMul example in FIG. 7, a MatMul of two matrices 225 with 235 is performed. Matrix 225 has dimensions K×N and matrix 235 has dimensions K×M. The output 255 has dimensions N×M, so the K dimension has been reduced. MatMul could be described with the 3D operation space of N, M, K.

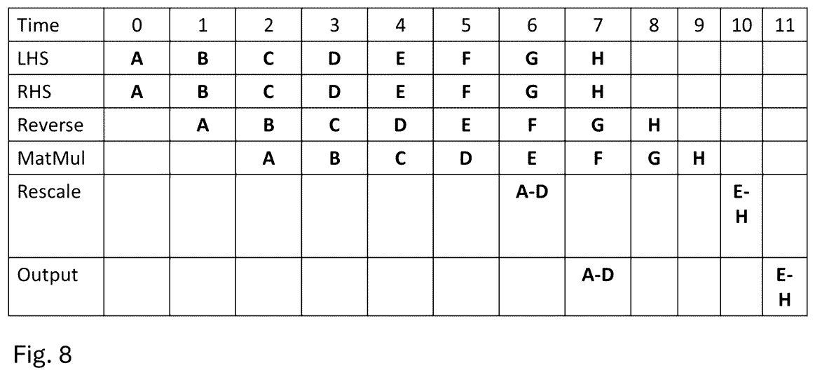

As will be appreciated the operations set out in FIG. 7 are sections which can be respectively executed by different execution units. The handling unit may be configured to control execution of the various blocks such that a particular block is able to flow through the progression of operations defined by the graph or sub-graph. The “A/E” notation in these figures illustrates that a block is being repeated. For example, blocks A and E have the same coordinates in some dimensions (K, N) but there is another dimension (M) that has changed but is not mapped into 220's coordinate space. The “A-D” notation indicates that blocks have been reduced and merged into a single block. E.g. blocks A, B, C, D have been reduced down into a single block. These blocks vary in dimension K but dimension K has been reduced. An example scheduling of the blocks set out in FIG. 7 is illustrated in FIG. 8.

FIG. 8 illustrates an example iteration through blocks for the progression of operations in FIGS. 6 and 7 for a series of invocation time instances 0 to 11. At time invocation time instance 0, block A is processed concurrently by execution units executing LHS and RHS read operations. These operations have no dependencies and in this example can be handled in a single invocation time instance and so are issued concurrently. Since LHS and RHS read operations are not dependent on one another, for all subsequent invocation time instances a next block (e.g. block B at time instance 1) is invoked for execution until all blocks A to H have been executed at time instance 7. This operation may still stall if there is not space in the destination pipe for that section.

Since the Reverse operation is a subsequent operation dependent on the output of the RHS read operation, the processing of block B by the Reverse operation can only be invoked at time instance 1. The processing of blocks by the Reverse operation is therefore delayed by one invocation time instance with respect to the RHS read operation. Similarly, the MatMul operation is dependent upon the output of the Reverse operation and so the MatMul processing of blocks is further delayed by one invocation time with respect to the Reverse operation.

Rescale operation operates on block of data which is derived from a set of four reduced blocks of data, e.g. A to D or E to H in a single invocation. As such, the Rescale operation is not invoked until all input dependencies have been met, i.e. that the MatMul operation has been performed on each of blocks A to D at time instance 6. Similarly, blocks E to H are not invoked for execution until time instance 10. The Output Write operation is dependent upon the completion of the Rescale operation and so is not invoked until time instance 7 for a block derived from the processing of blocks A to D, and similarly at time instance 11 for a block derived from the processing of blocks E to H.

In this way, the processing iterates through all the blocks until the complete operation space has been executed.

The process for generating an operation space from which each of these respective section spaces can be expressed will be described in more detail later but in this example the operation space for this progression of operations is taken to be the section space 245 for the MatMul operation 240 since all other section spaces can be expressed from the MatMul section space 245.

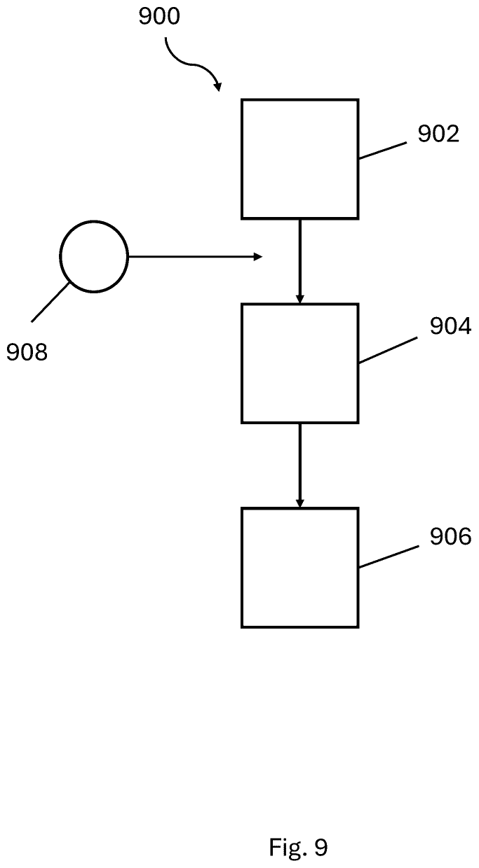

FIG. 9 illustrates a flow-chart of a data processing method 900. The data processing method 900 is carried out on a processor configured for handling task data and comprising a handling unit, a plurality of storage elements, and a plurality of execution units. The task data includes a program comprising transform program data that describes a transform from operation space to section space (local space) for a corresponding section. At step 902, the processor obtains from storage the task data in the form of a directed graph of operations. Each of the operations maps to a corresponding execution unit of the processor and each connection between operations in the directed graph maps to a corresponding storage element of the processor. At step 904, for each corresponding portion of the operation space, the method 900 includes transforming the portion of the operation space to generate respective operation specific local spaces for each of the plurality of the operations of the directed graph. At step 906, the method 900 includes dispatching to each of a plurality of the execution units associated with operations for which transformed local spaces have been generated, invocation data describing the operation-specific local space, and at least one of a source storage element and a destination storage element corresponding to a connection between the particular operation that the execution unit is to execute and a further adjacent operation in the directed graph to which the particular operation is connected. The processor is further configured, where necessary, to perform clipping 908 on lower and upper bounds of a task and operation space before running the transform.

### Vector Engine and Forwarding Pipes

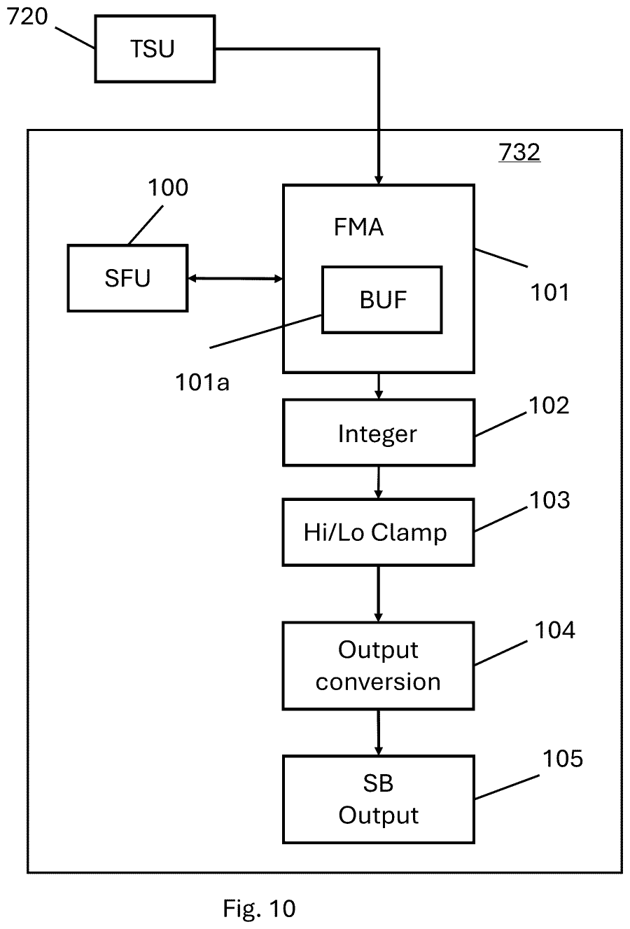

FIG. 10 shows more detail of an execution unit in the form of the vector engine 732 of a neural engine 652a. As explained above, the vector engine 732 receives task data from the handling unit (TSU) 720. A first portion of the vector engine 732 comprises a Floating Point Multiply/Add/Accumulate unit (FMA) 101 and a special function unit (SFU) 100. The FMA 101 provides functionality for floating point multiply, add, and accumulate operations. In some implementations, these may be one of the following operations:

$$A * B$$

$$A * B + ACC$$

$$A + B$$

$$A + ACC$$

where ACC is the value stored in an accumulator.

The accumulator (not shown) may make use of a storage in the vector engine 732 that may be formed of a number, n, of 32-bit storage locations.

The SFU 100 is a unit configured to perform polynomial approximation of transcendental functions. In some implementations, the SFU is configured to perform a third-order polynomial approximation using look-up tables to identify relevant coefficients. The SFU may approximate functions such as logarithm, sigmoid, tanh, reciprocal square root, etc. that are non-linear and cannot easily be calculated directly. In some implementations, the SFU may calculate values for functions other than transcendental functions.

The Vector engine 732 further comprises an integer processing unit 102 configured to perform processes on integer values including integer multiply/add/accumulate, integer bit shifting, logical operations (AND, OR, XOR, NOT), comparison and division.

A Hi/Lo Clamp unit 103 within the vector engine 732 is configured to reduce numbers to a required output format and is used for calculating values associated with the ReLU function.

An output conversion unit 104 is provided within the vector engine 732 that is configured to convert tensors between numerical formats. For example, the output conversion unit 104 may be configured to implement the casts specified in the TOSA specification. Examples include, but are not limited to, conversion from 16-bit floating point to 16-bit integer, conversion from 16-bit floating point to 8-bit floating point, conversion from 32-bit integer to 16-bit floating point etc. The output conversion unit 104 may also support stochastic rounding. In some implementations, some of the conversions, such as 16-bit floating point to 16-bit integer may be performed in other units, such as integer processing unit 102.

The shared buffer output unit 105 is configured to output the result of processing by the vector engine 732 and transfer the result to the shared storage 738. It is noted that while FIG. 10 shows single direction arrows within the vector engine 732, the vector engine may be configured to transfer data between the components shown in FIG. 10 in any order as appropriate depending on the configured functionality within the vector engine.

In a naïve implementation, the vector engine 732 may receive a sequence of a sequence of invocations each relating to one of a sequence of different operations. These operations will have been scheduled by the handling unit 720 and source and destination pipes would be allocated in the shared storage 738. However, where a sequence of operations is to be performed by the Vector engine 732 on data consecutively this approach leads to repeated writes to and reads from the shared storage 738 which consumes power and uses unnecessary storage as the storage in the shared storage 738 for each source and destination pipe needs to be allocated by the handling unit 720.

To improve power consumption and improve storage utilization in the shared storage 738 the following approaches may be implemented. A first approach will be referred to as barrel scheduling and second approach will be referred to as local buffering. According to each approach, the control originates with the compiler (e.g. graph compiler) that generates the task data that is sent to the processor 630. It is noted that compilation of instructions to be performed by the processor 630 is performed before the processor executes the task and may be performed a considerable time (i.e. not in real time with) before the task is processed by the processor.

According to some implementations, the compiler is configured to identify a plurality of sequential operations that are to be performed by a vector engine on data. As will be explained in more detail below, the compiler configures the NED with “forwarding pipe” configuration data to identify the plurality of sequential operations that should be performed by the vector engine 732.

Upon receipt of the task data generated by the compiler, the handling unit 720 parses the task data and identifies the plurality of operations configured with the “forwarding pipe” configuration data. The handling unit 720 generates a single invocation that includes the plurality of operations that occur in sequence and sends that group of operations in the invocation data to the vector engine 732.

When executing with barrel scheduling, the vector engine 732 reads data from the shared storage 738 and processes the sequence of operations so that as data is processed by the vector engine 732 the data is recycled without the need to write the output data to a storage, such as the shared storage 738. According to the local buffering approach, instead of immediately recycling the data, the data is stored on a storage local to the vector engine, such as buffer 101a shown in FIG. 10, rather than storing the data in the shared storage 738, which is not local to the vector engine 732. The local storage, e.g. buffer 101a, will typically be of smaller capacity than the shared storage 738, but will be able to store a small amount of data to make the processing by the vector engine 732 more efficient.

In more general terms, the local storage is a storage to which the vector engine 732, or more generally an execution unit, has faster or more energy efficient access to compared to the non-local storage, such as the shared buffer 738. The local storage may be included in the execution unit as in the described embodiment shown in FIG. 10. The local storage may be accessible by the execution unit but not by other execution units. The non-local storage may be a shared storage that is accessible by a plurality of execution units.

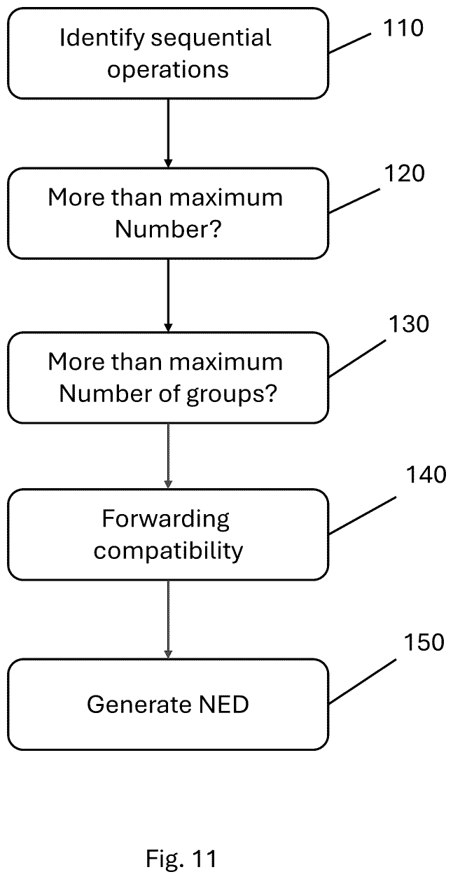

FIG. 11 is a flow chart showing steps performed by a compiler application to generate task data for a sequence of tasks to be performed by the vector engine 732. In general terms, a job to be processed by processor 630, such as processing of a neural network or other machine learning data, includes a series of operations that may be defined in terms of TOSA operations as discussed above. The compiler takes the job to be completed defined in terms of TOSA operations and generates the directed graph of task data that includes information on how the processor 630 is to perform the job.

FIG. 11 illustrates a part of the logic applied by the compiler to generate the task data to allow the processor to perform sequential operations on the vector engine 732. In step 110, while analyzing the TOSA operations to generate the NED for the task data, the compiler identifies sequential operations that are to be performed on a Vector engine 732 within the processor 630 on the same data. The operations that may be performed by the vector engine may include a group including, but not limited to: conversion to integer, conversion to floating point, determining an absolute value, counting leading zeros, a floor function, a ceiling function, addition, subtraction, multiplication, bit shifting, logical operations, determining a maximum, determining a minimum, performing comparison with a value, raising a value to a power, and applying a transcendental function

In step 120, the compiler identifies the number of sequential operations to be performed by the same type of execution unit (i.e. vector engine 732) and determines if they are greater than a predetermined maximum number. The reason for this identifying a maximum number is to avoid overloading handling unit 720. In particular, as will be explained further below, the handling unit 720 checks that all source pipes are available before issuing a group of operations to the execution unit. Accordingly, a maximum number of sequential operations will give a maximum number of source pipes for the handling unit 720 to check. The maximum number will vary from implementation-to-implementation of the processor. In some examples, the maximum number may be four.

If the number of sequential operations exceeds the maximum number, the compiler will break the sequential operations into multiple groups of operations such that each group does not include more than the maximum number of operations. The data will be written to and read from the shared storage 738 between groups of operations (which will eventually be included in separate invocations generated by the handling unit 720) in this case.

In step 130, the compiler may determine whether there are more than a maximum number of groups that have been formed including “forwarding pipe” configuration data. It may be desirable to limit the number of groups of operations that include forwarding in order to manage storage in the handling unit 720 required for controlling the forwarding groups, such as determining the number of operations in the groups, identifying the source pipes for each group, and determining the availability of the source pipes.

In step 140, the compiler checks forwarding compatibility. This covers additional logical restrictions that may be applied depending on the implementation. For example, it may be desirable to limit the sequential operations that are grouped so that they are all the same type (or member of a same group of types). Further, it may be desirable to limit the sequential operations so that they all operate on data having the same dimensions. In some implementations, the operations may be restricted to all operate on a same size of data except for a last operation in the group of sequential operations which may generate output data having different dimensions that is subsequently stored in the shared storage 738 in accordance with a configured output pipe. In some implementations, it may be desirable to restrict operations in the group to “element-wise” operations that are performed between two or more tensors, such that each operation only acts between corresponding elements in the tensors. In some implementations it may be desirable to limit a group of operations so that it only has a single destination pipe.

In step 150, the compiler generates NED for the task data. As described above, the NED typically includes at least a source pipe and a destination pipe for each operation. To indicate that the sequential operations should be scheduled together in a single invocation, a new value for the source or destination pipe field in the NED that identifies a logical ‘forwarding pipe’ is provided. Accordingly, for each group of sequential operations generated by the compiler, a first operation is configured with a source pipe that refers to a storage, such as the shared storage 738 or accumulator buffer 736, and a second operation is configured with a destination pipe that refers to a storage, such as the shared storage 738. The destination pipe for the first operation is set to “forwarding pipe” and the source pipe for the second operation is set to “forwarding pipe”. If the sequence of operations is longer than two (and less than the maximum number), intermediate operations are configured with both the source pipe and destination pipe indicating ‘forwarding pipe’. It is also possible for an intermediate operation to additionally read a source pipe that refers to storage as well as read from the logical forwarding pipe.

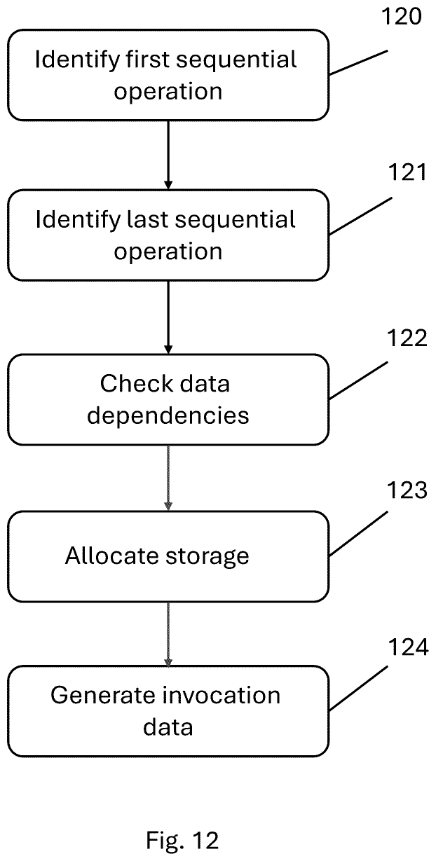

FIG. 12 is a flow chart showing steps performed by the handling unit 720 when parsing the task data received from the command processing unit 640 and generated by the compiler. In step 120 the handling unit 720 identifies a first operation that includes a destination pipe that is configured with the “forwarding pipe” value. In step 121, the handling unit 720 continues to parse the task data until a second operation is identified that is configured with “forwarding pipe” as its source pipe and with another value for the destination pipe, such as specifying storage in the shared storage 738.

In step 122, various checks are made. The checks may replicate some or all of the checks performed by the compiler, such as checking that there is not more than a maximum number of operations in a group to be included in a single invocation. Additionally, the handling unit will check all of the input pipes for the group of operations to determine whether the data is available and accordingly the invocation data is ready to be sent to the vector engine 732. The handling unit 720 will also check whether the vector engine 732 is available and not currently processing another invocation.

In step 123, when it has been determined that the group of operations is ready to be sent to the vector engine 732, the handling unit 720 identifies storage locations in the shared storage 738 corresponding to the source pipes for the group of operations and allocates a storage location in the shared storage 738 for the one or more destination pipe of the group of operations.

In step 124, the handling unit generates invocation data corresponding to the group of sequential operations and sends the invocation data to the vector engine 732. The group of sequential operations includes at least the first operation and the second operation and may include intermediate operations if the group of operations configured by the compiler contains more than two operations. The invocation data further includes information about the storage locations for the source and destination pipes.

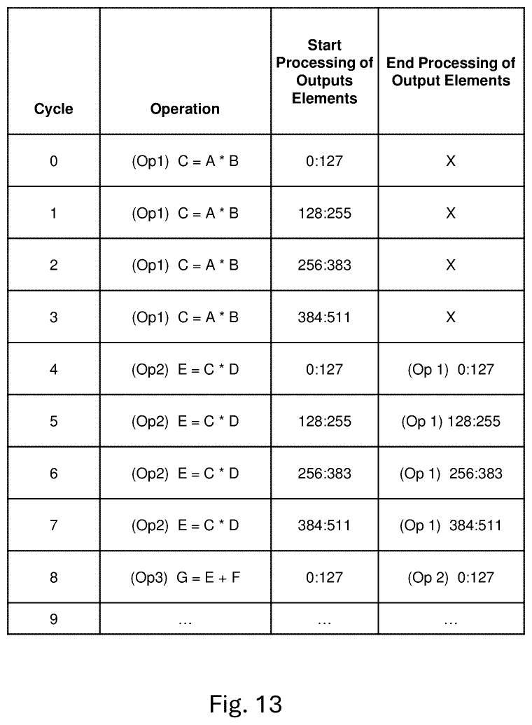

Barrel scheduling will now be described with reference to FIG. 13, which is a table showing the order of performance of operations by the vector engine 732 in response to receipt of the invocation data. FIG. 13 shows the performance of three example operations:

$$C = A * B \qquad Operation 1 :$$

$$E = C * D \qquad Operation 2 :$$

$$G = E + F \qquad Operation 3 :$$

It can be understood from the description above, that the invocation data has been configured with operation 1 having two source pipes to receive values for tensors A and B from the shared storage 738. The destination pipe has been configured as “forwarding pipe”. The second operation will have two input pipes, one configured as “forwarding pipe” to receive the tensor values C and the other configured as a source pipe to receive the tensor values D from the shared storage 738. The third operation will have two input pipes, one configured as “forwarding pipe” to receive the tensor values E from operation 2 and the other configured as a source pipe to receive tensor values F from the shared storage 738.

The operations shown will be performed by the FMA 101 in the vector engine 732. The FMA is assumed in this example to have a latency of four cycles, which is the time taken to perform an operation on a patch of data. The latency measured in number of cycles for different components will depend upon implementation details and may vary from embodiment-to-embodiment.

In cycles 0, 1, 2 and 3 shown in FIG. 13, the first operation is performed, and data is sequentially read from the shared storage 738 and processed by the FMA 101. In step 0, the first 128 elements are read and processed, in step 1 the second 128 elements are read and processed, in step 2, the third 128 elements are read and processed, and in step 3 the fourth 128 elements are read and processed. The elements are the values to be multiplied together.

In cycle 4, the elements from cycle 0 are completely processed by the FMA 101, by virtue of the four-cycle latency of the FMA 101. To avoid storing the output elements, the elements are recycled and reenter the FMA 101 to perform the second operation. Similar steps occur through cycles 4 to 7 whereby the output data from the first operation is feedback into the FMA 101 without being stored in an external storage, such as the shared storage 738. This is referred to as barrel scheduling. In step 8, and only partially illustrated, the same process is repeated for the third operation, whereby the results of the second operation initiated in cycle 4 become available and are immediately input to the FMA 101 for the third operation. This process is repeated for all the operations in the group until the final operation in the group is reached and the data is stored in the destination pipe, which corresponds to an allocated storage location in the shared storage 738. Once all of the operations have been completed for the first 128 elements, a new set of 128 elements may be read for the first operation, followed in the next cycle by another new set of 128 elements for the first operation as the second set of 128 elements completes processing. In this way, the FMA 101 iterates through all the operations and, as all the operations are completed for patches of data, sequentially through the data in the input pipes until the group of operations is completed.

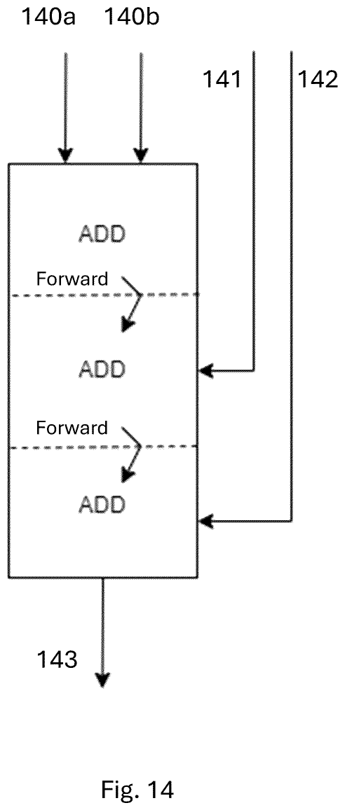

FIG. 14 is a schematic diagram illustrating a sequence of operations of the type just described. Three operations are illustrated in FIG. 14 but another number of two or more operations may be implemented. Further, each operation described in the examples herein takes two input pipes. However, in other implementations, different numbers of input pipes may be implemented. The first operation takes data from two source pipes 140a and 140b. The second operation is configured with a forwarding pipe as an input pipe so that it receives the output data of the first operation as input and further receives data from a source pipe 141. The third operation also takes data from a forwarding pipe so that it receives the output data of the second operation as input and further receives data from a source pipe 142.

The group of operations illustrated in FIG. 14 performs addition of four data values corresponding to data received via source pipes 140a, 140b, 141, and 142. It will be appreciated that different overall calculations may be performed by varying the nature of the operations from add to multiply etc.

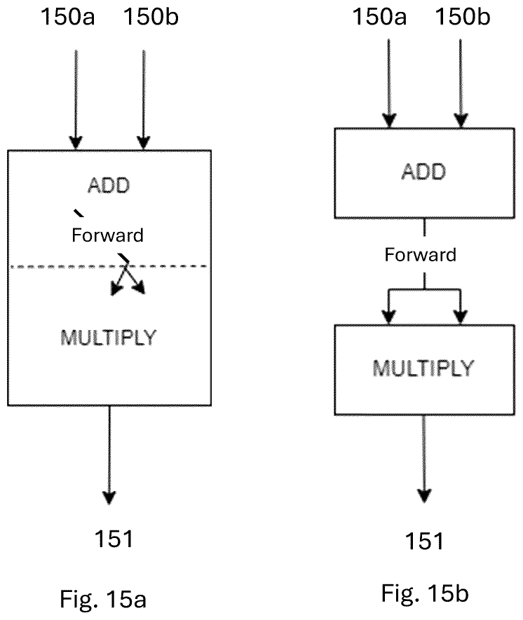

FIG. 15a is a schematic diagram showing a further sequence of two operations. The first operation takes data via two source pipes 150a and 150b. The first operation adds the two data values together. The second operation is a multiply operation, which does not receive data from a source pipe. Instead, the second operation is configured with two input pipes configured as “forwarding pipe”. The single output value from the first operation is input to the second operation as both inputs. In other words, the multiply operation multiplies the output of the first operation by itself i.e. a squared operation. The output of the second operation is sent to the shared storage 738 using a logical destination pipe 151.

FIG. 15b illustrates the second approach of local buffering. A local storage may be provided at the vector engine 732 to temporarily store data between operations. This may allow more flexibility than the barrel scheduling as will be illustrated further below. When using local buffering the output of the first operation is stored in the local storage, such as BUF 101a, and is read from the local storage for the second operation. This may be useful in implementations, such as illustrated in FIG. 15b, where the FMA 101 is configured to read the output of the first operation twice to perform the multiply operation. As with the example described in connection with FIG. 15a, the output of the second operation is stored in the shared storage 738 via the logical destination pipe.

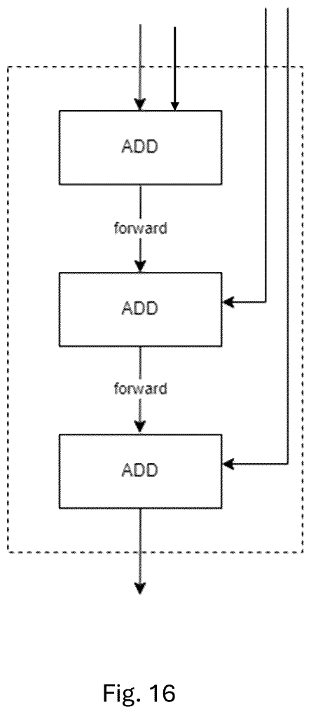

FIG. 16 is a schematic diagram corresponding to FIG. 14 that shows that addition of four operations can also be performed by implementations that use local storage. The outputs of each of the first operation and the second operation are stored in the local storage and are read as an input for the subsequent operation.

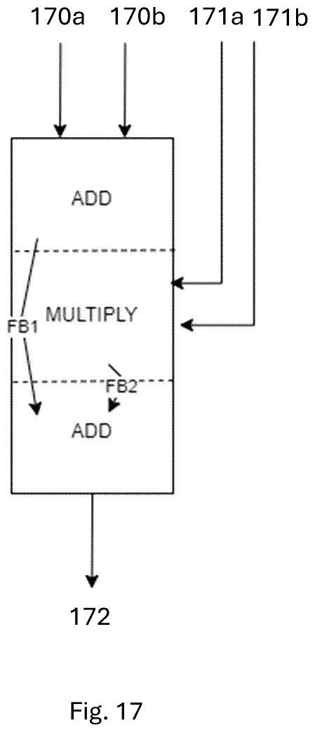

FIG. 17 illustrates a more complicated sequence of operations that demonstrate increased flexibility offered by local buffering. In particular, FIG. 17 shows an embodiment that supports named buffers. The first operation is an add operation that takes data from the shared storage 738 via two logical two source pipes 170a and 170b. The first operation is configured to output to the logical “forwarding pipe” and therefore stores the output data in the local buffer, 101a.

The second operation also receives data from the shared storage 738 via two logical source pipes 171a and 171b. The second operation multiplies the values received together and outputs the data to the third operation. The second operation does not make use of the output of the first operation, which remains stored in the local buffer, 101a.

The third operation is configured to receive data from two logical forwarding pipes. The output of the first operation is added to the output of the second operation. As noted above, the output of the first operation has been stored in the local storage, which was necessary while the second operation is performed. It is noted that the first and second operation could be swapped to obtain the same result, but in any case, at least one cycle's worth of data representing the first of the two calculations needs to be stored in the local storage 101a.

The output of second operation may be input to the third operation either by storing it in the local storage or by barrel scheduling. In some implementations, the local storage may comprise two or more logical storage regions that are indicated by respective identifiers. In such implementations, data may be stored in the local storage 101a in association with an identifier so that the data may be referenced for subsequent processing by an operation. In the example above, the stored output from the first operation and the second operation can therefore be distinguished using the identifiers. In some implementations, the compiler may be configured to generate configuration data for the forwarding pipe of an operation that includes the identifier.

The local storage 101a may be formed of one or more physical storage devices. The skilled person will appreciate that multiple storage devices may be controlled as one logical storage region. In other implementations, a single storage device may be divided into multiple logical storage regions, which are given separate identifiers.

The third operation, performed by the FMA 101, adds the output of the first operation and the second operation and outputs the result to the shared buffer via logical destination pipe 172.

More generally, in cases where both barrel scheduling and local buffering are implemented in an execution unit, the task data generated by the graph compiler may be configured to indicate which of barrel scheduling and local buffering should be performed. For example, this could be done by grouping operations within the NED in different manners or by adding a field or a flag associated with the forwarding pipe to indicate which of barrel scheduling and local buffering should be performed by the execution unit.

The examples above show example operations that take two inputs including one or two inputs from the logical “forwarding pipe”. However, some operations may only take a single input, such as a ceiling or floor function. These functions which take a single input may also take input from the logical “forwarding pipe”.

With the local storage approach, it is possible for there to be only some (e.g. only one) but not all of the subsequent operations (after the first operation) in the sequence of operations that use output data from a previous operation in the sequence of operations as input data. In some implementations, each operation after the first operation in the sequence of operations uses output data from a previous operation in the sequence of operations as input data.

The operations described above were described in connection with the FMA 101. However, the same approach may be adopted with units described above, such as the SFU 100, integer unit 102, Hi/Lo clamp unit 103 and output conversion unit 104. For example, a first operation in a group of operations could be an add function performed by FMA 101, the second function could be a log function performed by the SFU 100 and a third function could be a multiply operation performed by the FMA 101. Other combinations of functions may be configured as desired.

In some implementations, the compiler may be configured to use the logical forwarding pipe to implement certain architecturally supported operations (TOSA operations) as a series of operations. For example, the operation:

$$y = {e}^{x}$$

may be implemented as a combination of:

$$t 1 = x * 1.44269502$$

$$y = EXP 2 ( t 1 )$$

where 1.44269502 is an approximate value of log₂(e).

In this case, the SFU only needs to support determination of the exponents to the power of base 2 and the extra functionality can be implemented by the compiler. The compiler may identify the TOSA function and implement the function with a combination of Vector engine 732 operations in the task data. The operations would form a group with configured forwarding pipes linking the operations. Similar combinations of operations may be performed for other operations. For example, y=log (x) may be converted to a combination of operations including determining log₂(x) using SFU 100.

The replacement of an operation, such as a transcendental function, by a plurality of operators, such as linear operators, that approximate the transcendental function as described above, may be performed by the compiler. In other implementations, the identification and replacement of the non-natively supported operation could be performed at the processor by the handling unit 720 or by logic configured within the vector engine 732. The handling unit 720 may identify the predetermined operation to be replaced within the task data and may replace the predetermined operation with a group of operations linked by forwarding pipes when generating the invocation data. Alternatively, the vector engine 732 may identify the predetermined operation within the invocation data received from the handling unit 720. In this case, the vector engine 732 will apply logic to perform the sequence of operations on the vector engine without storing any intermediate data in the shared storage 738.

The above example has provided a detailed description of use of a logical forwarding pipe within the vector engine 732. However, the concept of a logical “forwarding pipe” that keeps the data local to the execution unit either by barrel scheduling and/or by use of a local buffer is applicable to other execution units such as the transform unit 734. In such implementations where multiple execution units can perform groups of operations, logic may be introduced to the compiler to prevent the use of the logical forwarding pipe between different execution units.

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

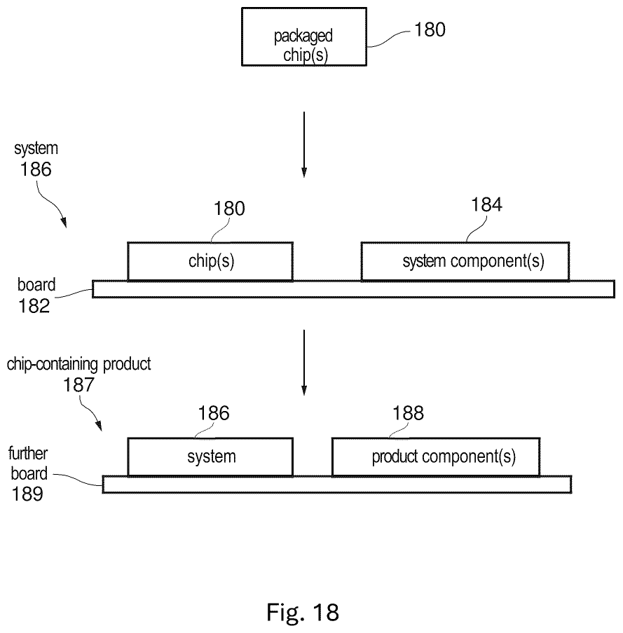

As shown in FIG. 18, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Embodiments

A first further embodiment provides processing unit, comprising a handling unit and an execution unit, wherein the handling unit is configured to: receive task data in the form of a directed graph including at least a first operation and a second operation, wherein the task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe; parse the task data to form invocation data to send to an execution unit within the processing unit, wherein the operations included in the invocation data are determined by parsing the task data to identify the first and second operations; map the first and second operation of the task data to the execution unit and allocate storage in a non-local storage that is remote from the execution unit for the logical source pipe and logical destination pipe; and send the invocation data including the first and second operation to the execution unit to cause the execution unit to process the invocation data by: obtaining data from the non-local storage based on the logical source pipe of the first operation, performing the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.

In some implementations the execution unit is configured to store the output of the first operation in a local storage that is local to the execution unit. In such implementations, the configuration data may further comprise an identifier of a plurality of identifiers for the logical forwarding pipe. The execution unit may store the output of the first operation in the local storage is association with the identifier. Alternatively or in addition, any intermediate operations between the first operation and the second operation may store their output in the local storage associated with the same or a different identifier.

The execution unit may be configured to operate in cycles. Processing the first operation on the portion of data may take a predetermined number of cycles to be performed by the execution unit. The execution unit may perform the processing for the portion of the data received from the logical source pipe by performing processing for the first operation for the predetermined number of cycles. After the predetermined number of cycles, the execution unit may forward the output of processing for the first operation for use in processing, by the execution unit, for a subsequent operation for the portion of the data.

The execution unit may be configured to process the invocation data such that the first operation and the second operation are completed for the portion of the data from the logical source pipe before processing for the first operation is completed for all the data from the logical source pipe.

In some implementations, at least one of the first operation and second operation is configured with at least two input pipes. In such implementations, at least one of the first operation and second operation may be configured to receive the same data via the two input pipes.

The invocation data may comprise one or more intermediate operations. The first operation, second operation, and intermediate operation may be configured to be performed sequentially such that the first operation is configured to output first output data to the logical forwarding pipe, the intermediate operation is configured to receive the first output data from the logical forwarding pipe and to output second output data to the logical forwarding pipe, and the second operation is configured to receive the second output data from the logical forwarding pipe.

In some implementations in which the invocation data is configured to perform one or more intermediate operation, the first operation, second operation, and intermediate operation may be performed in a graph such that the first operation is configured to output first output data to the logical forwarding pipe, the intermediate operation is configured to output second output data to the logical forwarding pipe, and the second operation is configured to receive the first output data and the second output data from the logical forwarding pipe.

The second operation may be configured to receive data from the logical forwarding pipe and to receive data from a second logical source pipe that maps to the non-local storage.

The handling unit may be configured to send the invocation data to the execution unit containing at most a predetermined maximum number of sequential operations that refer to the logical forwarding pipe. The predetermined maximum number of sequential operations may be enforced by logic in a compiler.

The first operation and second operation may be selected from a group comprising: conversion to Unary, conversion to Binary, conversion to floating point, determining an absolute value, counting leading zeros, a floor function, a ceiling function, addition, subtraction, multiplication, bit shifting, logical operations, determining a maximum, determining a minimum, performing comparison with a value, raising a value to a power, and applying a transcendental function.

The execution unit may be a vector processing unit configured to perform a mathematical operation on one or more vector of data.

The logical source pipe and the logical destination pipe may be mapped to storage locations in the non-local storage. The logical forwarding pipe may not be mapped to the non-local storage. The logical forwarding pipe may be mapped or associated with a portion of a local storage.

The first operation may be a first operation in a sequence of operations. The second operation may be a last operation in the sequence of operations. Intermediate operations between the first operation and the second operation may be configured to read data from and store data to the logical forwarding pipe.

The dimensions of data received from the logical source pipe by the first operation and data received by intermediate operations in the sequence of operations from the logical forwarding pipe may have a first set of dimensions. The dimensions of the data output by the second operation to the logical destination pipe may have a second set of dimensions that is different from the first set of dimensions.

The handling unit may be configured to determine whether data is available for all the logical source pipes within the invocation data before sending the invocation data to the execution unit.

The processor may be further configured to parse the task data to form second invocation data to send to an execution unit within the processing unit, wherein the invocation data consists of a third operation that receives data from a logical source pipe and outputs data to a logical destination pipe. The handling unit may be configured to map the third operation of the task data to the execution unit and allocate storage in the non-local storage for the logical source pipe and logical destination pipe of the third operation. The processor may be configured to send the invocation data including the third operation to the execution unit to cause the execution unit to process the invocation data.

In some implementations, the processing unit, such as the handling unit or execution unit, may be configured to identify a predetermined operator within the task data. The processing unit may be configured to replace the predetermined operator with a predetermined plurality of operations linked by forwarding pipes. The predetermined operator may be an operator corresponding to a transcendental function. The predetermined plurality of operations may be linear operations that approximate the transcendental function. The processing unit may be configured to perform the processing for the predetermined operation as a series of operations without storing the output data in the non-local storage.

A second further embodiment may provide a system comprising: the processing unit of the first further embodiment, implemented in at least one packaged chip; at least one system component; and a board, wherein the at least one packaged chip and the at least one system component are assembled on the board. A chip-containing product may be provided comprising the system of the second further embodiment, wherein the system is assembled on a further board with at least one other product component.

A non-transitory computer-readable medium may be provided having stored thereon computer-readable code for fabrication of the processing unit of the first further embodiment.

A third further embodiment may be method of performing a plurality of operations in a processing unit, comprising: receiving task data in the form of a directed graph, by a handling unit of the processing unit, including a first operation and a second operation, wherein task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe; parsing, by the handling unit, the task data to form invocation data to send to an execution unit within the processing unit, wherein the operations included in the invocation data are determined by parsing the task data to identify the first and second operations; mapping the first and second operation of the task data to the execution unit and allocating storage in a non-local storage that is remote from the execution unit for the logical source pipe and logical destination pipe; sending the invocation data including the first and second operation to the execution unit; and processing the invocation data, by the execution unit, by obtaining data from a non-local storage that is remote from the execution unit based on the logical source pipe of the first operation, performing the first and second operation for portions of the data received from the logical source pipe, wherein in response to the output of the first operation and input of the second operation referring to the logical forwarding pipe, the execution unit performs the processing for the first and second operation for a portion of the data without storing the output data of the first operation in the non-local storage.

The method may include features of the first further embodiment.

A fourth further embodiment may comprise non-transitory computer-readable storage medium storing computer-readable instructions for a compiler that, when executed by a processing unit, cause the processing unit to generate task data in the form of a directed graph including a first operation and a second operation, wherein the task data includes configuration data that indicates that the first operation receives data from a logical source pipe and that the second operation outputs data to a logical output pipe, and wherein the configuration data indicates that the first operation outputs data to a logical forwarding pipe and the second operation receives data from the logical forwarding pipe; wherein, when processed by an execution unit in a second processing unit, an execution unit of the second processing unit is caused to: obtain data from a non-local storage based on the logical source pipe of the first operation, perform the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.

The compiler may be a graph compiler. The graph compiler may be configured to generate the task data from an instruction set defining a job. The instruction set may be a set of Tensor Operator Set Architecture instructions. The job may be processing of a neural network.

The compiler may be configured to identify consecutive instructions in the instruction set that are performed by a single execution unit. The compiler may be configured to determine whether there are more than a predetermined number of consecutive instructions that are to be performed by a single execution unit.

The compiler may be configured to identify the first and second operations to form a group of operations that have no more than the predetermined number of operations.

The compiler may be configured to determine whether the consecutive operations are of the same type or are in a group of operations of the same type and to identify the first and second operation so that the group of operations includes only operations of the same type or within the group of operations of the same type. The group of operations of the same type may be a group of element-wise operations.

The compiler may be configured to determine whether the consecutive operations process data having the same dimensions. The compiler may identify the first and second operation so that the group of operations includes only operations that process data having the same dimensions. In some implementations, the second operation may be identified that processes data having different dimensions from the first operation and any intermediate operations.

In a case that the group of operations comprises three or more operations including the first operation and the second operation, the compiler may configure intermediate operations with configuration data that indicates an input to the intermediate operation is the logical forwarding pipe and an output of the intermediate operation is the logical forwarding pipe.

The compiler may be configured to identify a predetermined operator within the task data. The compiler may be configured to replace the predetermined operator with a predetermined plurality of operations linked by forwarding pipes. The predetermined operator to be replaced may be an operator corresponding to a transcendental function. The predetermined plurality of operations may be linear operations that approximate the transcendental function.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A processing unit, comprising a handling unit and an execution unit, wherein the handling unit is configured to:
receive task data in the form of a directed graph including at least a first operation and a second operation, wherein the task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe;
parse the task data to form invocation data to send to an execution unit within the processing unit, wherein the operations included in the invocation data are determined by parsing the task data to identify the first and second operations;
map the first and second operation of the task data to the execution unit and allocate storage in a non-local storage that is remote from the execution unit for the logical source pipe and logical destination pipe; and
send the invocation data including the first and second operation to the execution unit to cause the execution unit to process the invocation data by:
obtaining data from the non-local storage based on the logical source pipe of the first operation,
performing the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.

2. A processing unit according to claim 1, wherein the execution unit is configured to store the output of the first operation in a local storage that is local to the execution unit.

3. A processing unit according to claim 2, wherein the configuration data further comprises an identifier of a plurality of identifiers for the logical forwarding pipe, wherein the execution unit stores the output of the first operation in the local storage in association with the identifier.

4. A processing unit according to claim 1, wherein the execution unit is configured to:
operate in cycles, wherein processing the first operation on the portion of data takes a predetermined number of cycles to be performed by the execution unit,
perform the processing for the portion of the data received from the logical source pipe by performing processing for the first operation for the predetermined number of cycles, and
after the predetermined number of cycles forward the output of processing for the first operation for use in processing, by the execution unit, for a subsequent operation for the portion of the data.

5. A processing unit according to claim 4, wherein the execution unit is configured to process the invocation data such that the first operation and the second operation are completed for the portion of the data from the logical source pipe before processing for the first operation is completed for all the data from the logical source pipe.

6. A processing unit according to claim 1, wherein at least one of the first operation and second operation is configured with at least two input pipes.

7. A processing unit according to claim 6, wherein at least one of the first operation and second operation is configured to receive the same data via the two input pipes.

8. A processing unit according to claim 6, wherein the invocation data comprises one or more intermediate operations, wherein the first operation, second operation, and intermediate operation are configured to be performed sequentially such that the first operation is configured to output first output data to the logical forwarding pipe, the intermediate operation is configured to receive the first output data from the logical forwarding pipe and to output second output data to the logical forwarding pipe, and the second operation is configured to receive the second output data from the logical forwarding pipe.

9. A processing unit according to claim 6, wherein the invocation data is configured to perform one or more intermediate operation, wherein the first operation, second operation, and intermediate operation are performed in a graph such that the first operation is configured to output first output data to the logical forwarding pipe, the intermediate operation is configured to output second output data to the logical forwarding pipe, and the second operation is configured to receive the first output data and the second output data from the logical forwarding pipe.

10. A processing unit according to claim 1, wherein the handling unit is configured to send the invocation data to the execution unit containing at most a predetermined maximum number of sequential operations that refer to the logical forwarding pipe, wherein the predetermined maximum number of sequential operations is enforced by logic in a compiler.

11. A processing unit according to claim 1, wherein the first operation and second operation are selected from a group comprising: conversion to integer, conversion to floating point, determining an absolute value, counting leading zeros, a floor function, a ceiling function, addition, subtraction, multiplication, bit shifting, logical operations, determining a maximum, determining a minimum, performing comparison with a value, raising a value to a power, and applying a transcendental function.

12. A processing unit according to claim 1 wherein the first operation is a first operation in a sequence of operations and the second operation is a last operation in the sequence of operations, wherein intermediate operations between the first operation and the second operation are configured to read data from and store data to the logical forwarding pipe.

13. A processing unit according to claim 12, wherein the dimensions of data received from the logical source pipe by the first operation and data received by intermediate operations in the sequence of operations from the logical forwarding pipe have a first set of dimensions.

14. A processing unit according to claim 13, wherein the dimensions of the data output by the second operation to the logical destination pipe has a second set of dimensions that is different from the first set of dimensions.

15. A processing unit according to claim 1, wherein the processing unit is configured to identify a predetermined operator within at least one of the task data and invocation data and to perform the processing for the predetermined operation as a series of operations without storing the output data in the non-local storage.

16. A system comprising:
the processing unit of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A non-transitory computer-readable medium having stored thereon computer-readable code for fabrication of the processing unit of claim 1.

19. A method of performing a plurality of operations in a processing unit, comprising:
receiving task data in the form of a directed graph, by a handling unit of the processing unit, including a first operation and a second operation, wherein task data includes configuration data that indicates that the first operation receives data from a logical source pipe and that the second operation outputs data to a logical destination pipe, and wherein the configuration data indicates that the first operation outputs data to a logical forwarding pipe and the second operation receives data from the logical forwarding pipe;
parsing, by the handling unit, the task data to form invocation data to send to an execution unit within the processing unit, wherein the operations included in the invocation data are determined by parsing the task data to identify the first and second operations;
mapping the first and second operation of the task data to the execution unit and allocating storage in a non-local storage that is remote from the execution unit for the logical source pipe and logical destination pipe;
sending the invocation data including the first and second operation to the execution unit; and
processing the invocation data, by the execution unit, by obtaining data from a non-local storage that is remote from the execution unit based on the logical source pipe of the first operation, performing the first and second operation for portions of the data received from the logical source pipe, wherein in response to the output of the first operation and input of the second operation referring to the logical forwarding pipe, the execution unit performs the processing for the first and second operation for a portion of the data without storing the output data of the first operation in the non-local storage.

20. A non-transitory computer-readable storage medium storing computer-readable instructions for a compiler that, when executed by a processing unit, cause the processing unit to generate task data in the form of a directed graph including a first operation and a second operation, wherein the task data includes configuration data that indicates that the first operation receives data from a logical source pipe and that the second operation outputs data to a logical output pipe, and wherein the configuration data indicates that the first operation outputs data to a logical forwarding pipe and the second operation receives data from the logical forwarding pipe;
wherein, when processed by an execution unit in a second processing unit, an execution unit of the second processing unit is caused to:
obtain data from a non-local storage based on the logical source pipe of the first operation,
perform the first and second operation for portions of the data received from the logical source pipe, wherein in response to the output of the first operation and input of the second operation referring to the logical forwarding pipe, the execution unit performs the processing for a portion of the data for the first and second operation without storing the output data of the first operation in the non-local storage.
